(19) United States
(12) Patent Application Publication
(10) Pub. No.: US 2011/0242395 A1
(43) Pub. Date: Oct. 6, 2011

(54) ELECTRONIC DEVICE AND IMAGE SENSING DEVICE

(75) Inventors: Akihiko YAMADA, Daito City (JP); Toshitaka Kuma, Osaka City (JP); Kaihei Kuwata, Kyoto City (JP)

(73) Assignee: SANYO ELECTRIC CO., LTD., Moriguchi City (JP)

(21) Appl. No.: 13/077,536

(22) Filed: Mar. 31, 2011

(30) Foreign Application Priority Data
Apr. 1, 2010 (JP) 2010-085390
Apr. 9, 2010 (JP) 2010-090220

(51) Int. Cl. H04N 5/225

(52) U.S. Cl. 348/333.02; 348/E05.025

(57) ABSTRACT

An electronic device includes: a display portion that includes a display screen on which an input image is displayed; a specification reception portion that receives an input indicating a specified position on the input image; an object type detection portion that detects the type of object in the specified position based on image data on the input image; and a display menu production portion that produces a display menu displayed on the display screen. In the electronic device, the display menu production portion changes details of the display menu according to the type of object detected by the object type detection portion.

This nonprovisional application claims priority under 35 U.S.C. §119(a) on Patent Application No. 2010-085390 filed in Japan on Apr. 1, 2010 and on Patent Application No. 2010-090220 filed in Japan on Apr. 9, 2010, the entire contents of which are hereby incorporated by reference.

### BACKGROUND OF THE INVENTION

1. Field of the Invention

The present invention relates to an electronic device such as an image sensing device or an image reproduction device, and also relates to an image sensing device such as a digital camera.

2. Description of Related Art

In recent years, digital cameras having a touch panel feature have been commercially used, and this facilitates enhancement of operability. For example, in a first conventional method, a pressed portion of a touch panel is detected, and, with respect to the pressed position, operation buttons such as a shutter button, a zoom-up button and a zoom-down button are displayed around the pressed position. These operation buttons are displayed by being superimposed on a shooting image. With the first conventional method, it is possible to provide an instruction to shoot a still image or the like by performing an operation of pressing the touch panel, with the result that enhancement of operability is expected.

However, in the first conventional method, although the positions where the operation buttons are displayed are only changed depending on the pressed position of the touch panel, the details of the operation buttons displayed always remain the same. The position touched by a user' finger includes information indicating the intention of the user, and, if the operation buttons and the like for satisfying the intension of the user can be displayed by utilizing such information, convenience is further enhanced. Although the conventional technology on an image sensing device such as a digital camera has been described, the same is true on other electronic devices (such as an image reproduction device) that are not classified into the image sensing device.

For example, a second conventional method is commercially used in which, when a finger touches a display screen, focus control or exposure control is performed on a noted subject that is arranged in the pressed position of a touch panel.

Moreover, for example, the third conventional method is proposed in which, when a finger touches a display screen, with respect to the pressed position of a touch panel, operation buttons such as a shutter button, a zoom-up button and a zoom-down button are displayed around the pressed position. These operation buttons are displayed by being superimposed on a shooting image. The shutter button displayed on the display screen is pressed down to shoot a target image.

In the second conventional method, after the focus control or the exposure control is performed, it is further necessary to perform an operation of pressing down the shutter button in order to actually acquire a desired target image. In other words, in order to acquire the desired target image, it is necessary to perform the touch panel operation and the button operation, with the result that it is time-consuming.

When, as in the third conventional method, the shutter button is provided on the display screen, it is possible to finish providing an instruction to shoot the target image by touching the shutter button on the display screen. In other words, it is possible to finish providing the instruction to shoot the target image by performing only the touch panel operation (operation of pressing the display screen). However, since the shutter button on the display screen is pressed and this causes a digital camera to shake, the target image obtained immediately after the shutter button on the display screen is pressed down is often blurred.

### SUMMARY OF THE INVENTION

According to the present invention, there is provided an electronic device including: a display portion that includes a display screen on which an input image is displayed; a specification reception portion that receives an input indicating a specified position on the input image, an object type detection portion that detects the type of object in the specified position based on image data on the input image; and a display menu production portion that produces a display menu displayed on the display screen. In the electronic device, the display menu production portion changes details of the display menu according to the type of object detected by the object type detection portion.

In the image sensing device according to the present invention and including a display portion having a touch panel, the image sensing device shoots a target image either when an operation member comes in contact with a display screen of the display portion and thereafter the operation member is separated from the display screen or when the operation member comes in contact with the display screen and thereafter the operation member moves on the display screen while in contact with the display screen.

The significance and effects of the present invention will be further made clear from the description of embodiments below. However, the following embodiments are simply some of embodiments according to the present invention, and the present invention and the significance of the term of each of components are not limited to the following embodiments.

### BRIEF DESCRIPTION OF THE DRAWINGS

FIG. 1 is an entire block diagram schematically showing an image sensing device according to a first embodiment of the present invention;

FIG. 2 is a diagram showing the internal configuration of an image sensing portion of FIG. 1;

FIG. 3A shows an external plan view of the image sensing device of FIG. 1, and FIG. 3B is a diagram illustrating the configuration of a cross key provided in the image sensing device of FIG. 1;

FIG. 4 is an exploded view schematically showing a touch panel included in a display portion of FIG. 1;

FIGS. 5A and 5B are respectively a diagram showing a relationship between a display screen and an XY coordinate plane and a diagram showing a relationship between a second-dimensional image and the XY coordinate plane;

FIG. 6 is a partial block diagram of the image sensing device that is particularly involved in the operation of the first embodiment of the present invention;

FIG. 7 is a diagram showing how an image processing portion of FIG. 1 produces a target image from an original image;

FIGS. 8A and 8B are respectively a diagram showing a target image shot in a scenery mode and a diagram showing a target image shot in a portrait mode;

FIG. 9 is a diagram showing an example of a display screen in the first embodiment of the present invention;

FIG. 10 is a diagram showing how the display screen is changed and an example of the target image obtained when a user shoots the target image in the first embodiment of the present invention;

FIG. 11 is a diagram showing how a determination region is set in an input image in the first embodiment of the present invention;

FIGS. 12A, 12B and 12C are respectively a diagram showing a basic icon which is the basis of a display menu, a diagram showing an example of the display menu and a diagram showing the configuration of the basic icon, in the first embodiment of the present invention;

FIGS. 13A to 13E are diagrams illustrating item selection operation methods;

FIG. 14 is a diagram showing how another determination region is set in the input image in the first embodiment of the present invention;

FIG. 15 is a diagram showing another example of the display menu in the first embodiment of the present invention;

FIG. 16 is an operational flow chart of the image sensing device according to the first embodiment of the present invention;

FIG. 17 is a diagram showing a variation of the display menu in the first embodiment of the present invention;

FIG. 18 is a partial block diagram of an image sensing device that is particularly involved in the operation of a second embodiment of the present invention;

FIG. 19 is a diagram showing the structure of an image file in the second embodiment of the present invention;

FIG. 20 is a diagram showing the details of additional data stored in a header region of the image file in the second embodiment of the present invention;

FIG. 21 is a diagram showing how six division blocks are set in an arbitrary still image in the second embodiment of the present invention;

FIG. 22 is a diagram showing an example of a reference image read from a recording medium in the second embodiment of the present invention;

FIG. 23 is a diagram showing how the display screen is changed in the second embodiment of the present invention;

FIG. 24 is a diagram showing how the determination region is set in the reference image in the second embodiment of the present invention;

FIG. 25 is a diagram showing an example of the display menu in the second embodiment of the present invention;

FIGS. 26A and 26B are diagrams showing other examples of the display menu in the second embodiment of the present invention;

FIG. 27 is an operational flow chart of the image sensing device according to the second embodiment of the present invention;

FIG. 28 is a diagram showing a variation of the display menu in the second embodiment of the present invention;

FIG. 29 is a partial block diagram of an image sensing device according to a fourth embodiment of the present invention;

FIG. 30 is a diagram showing an example of the display screen in the fourth embodiment of the present invention;

FIG. 31 is a diagram showing how the display screen is changed and an example of the target image obtained when the user shoots the target image in a shooting operation example J₁ in the fourth embodiment of the present invention;

FIG. 32 is a diagram showing how the display screen is changed and an example of the target image obtained when the user shoots the target image in a shooting operation example J₂, in the fourth embodiment of the present invention;

FIGS. 33A and 33B are diagrams illustrating a touch position movement operation in the fourth embodiment of the present invention;

FIG. 34 is a diagram showing the display screen immediately before the user provides an instruction to shoot the target image in the shooting operation example J₂ in the fourth embodiment of the present invention; and

FIGS. 35A and 35B are diagrams showing how an AF evaluation region and an AE evaluation region are set in the input image in a fifth embodiment of the present invention.

### DETAILED DESCRIPTION OF PREFERRED EMBODIMENTS

Some embodiments of the present invention will be specifically described below with reference to the accompanying drawings. In the referenced drawings, like parts are identified with like symbols, and their description will not be repeated in principle.

### First embodiment

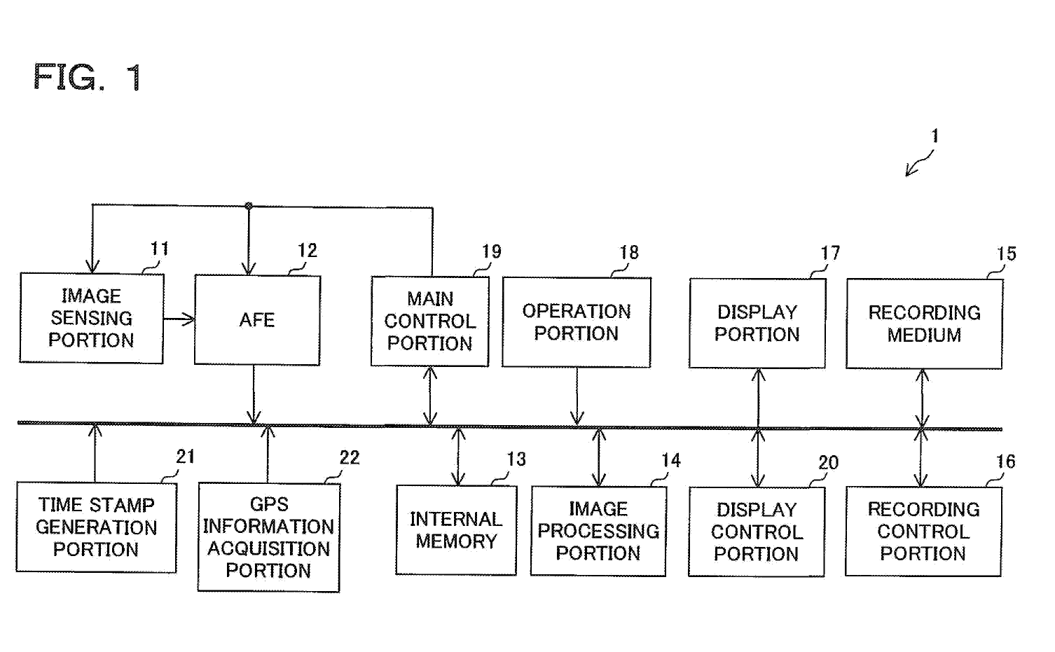

A first embodiment of the present invention will be described. FIG. 1 is an entire block diagram schematically showing an image sensing device 1 of the first embodiment. The image sensing device 1 is either a digital still camera that can shoot and record a still image or a digital video camera that can shoot and record a still image and a moving image.

The image sensing device 1 includes individual portions represented by reference numerals 11 to 22. Information (such as a signal or data) output from one component within the image sensing device 1 can be freely referenced by the other components within the image sensing device 1.

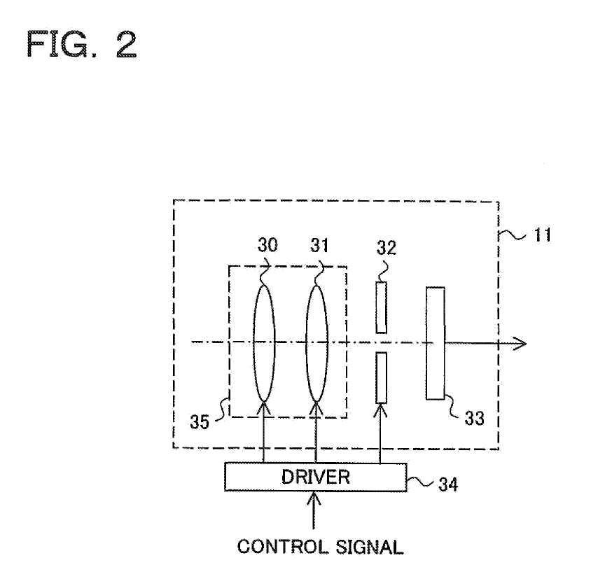

In FIG. 2, a diagram showing the internal configuration of the image sensing portion 11 is shown. The image sensing portion 11 includes an optical system 35, an aperture 32, an image sensor 33 formed with a CCD (charge coupled device), a CMOS (complementary metal oxide semiconductor) image sensor or the like and a driver 34 that drives and controls the optical system 35 and the aperture 32. The optical system 35 is formed with a plurality of lenses including a zoom lens 30 and a focus lens 31. The zoom lens 30 and the focus lens 31 can move in the direction of an optical axis. The driver 34 drives and controls, based on a control signal from the main control portion 19, the positions of the zoom lens 30 and the focus lens 31 and the degree of opening of the aperture 32, and thereby controls the focal length (angle of view) and the focus position of the image sensing portion 11 and the amount of light entering the image sensor 33 (that is, an aperture value).

The image sensor 33 photoelectrically converts an optical image that enters the image sensor 33 through the optical system 35 and the aperture 32 and that represents a subject, and outputs to the AFE 12 an electrical signal obtained by the photoelectrical conversion. Specifically, the image sensor 33 has a plurality of light receiving pixels that are two-dimensionally arranged in a matrix, and each of the light receiving pixels stores, in each round of shooting, a signal charge having the amount of charge corresponding to an exposure time. Analog signals having a size proportional to the amount of stored signal charge are sequentially output to the AFE 12 from the light receiving pixels according to drive pulses generated within the image sensing device 1.

The AFE 12 amplifies the analog signal output from the image sensing portion 11 (image sensor 33), and converts the amplified analog signal into a digital signal. The AFE 12 outputs this digital signal as RAW data. The RAW data refers to one type of image data on an image of the subject. The amplification factor of the signal in the AFE 12 is controlled by the main control portion 19.

The internal memory 13 is formed with an SDRAM (synchronous dynamic random access memory) or the like, and temporarily stores various types of digital data utilized within the image sensing device 1. The image processing portion 14 performs necessary image processing on image data on an image recorded in the internal memory 13 or the recording medium 15. The recording medium 15 is a nonvolatile memory such as a magnetic disk or a semiconductor memory. The image data resulting from the image processing performed by the image processing portion 14 and the RAW data can be recorded in the recording medium 15. The recording control portion 16 performs recording control necessary for recording various types of data in the recording medium 15. The display portion 17 displays an image resulting from shooting by the image sensing portion 11, the image recorded in the recording medium 15 or the like. In the present specification, a display and a display screen simply refer to a display on the display portion 17 and the display screen of the display portion 17, respectively.

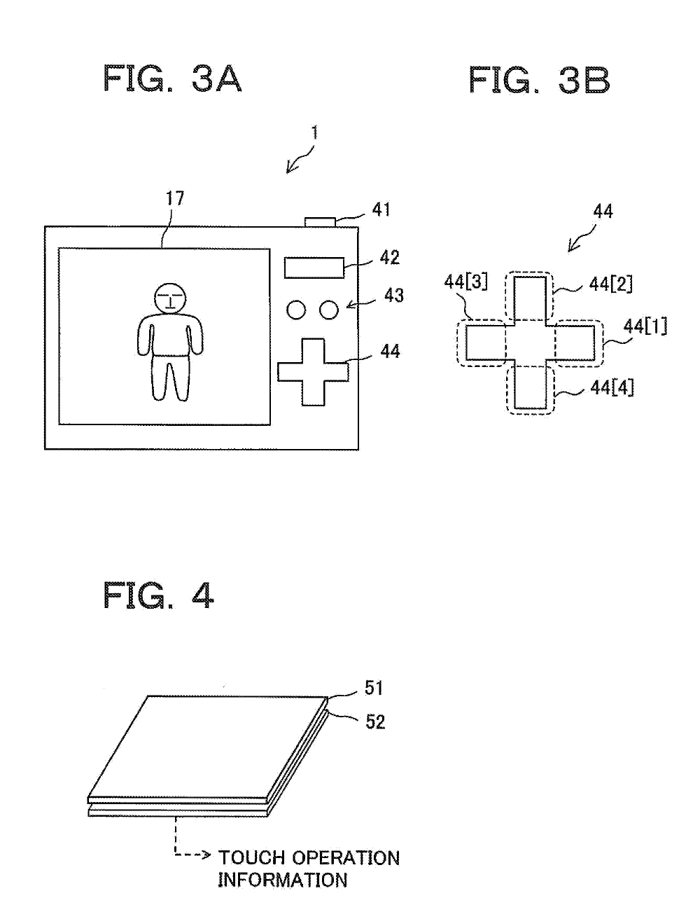

The operation portion 18 is a portion through which a user performs various operations on the image sensing device 1. FIG. 3A shows an external plan view of the image sensing device 1 seen in a direction in which to directly face the display screen of the display portion 17. FIG. 3A shows that a person who is a subject is displayed on the display portion 17. The operation portion 18 is provided with a shutter button 41 that provides an instruction to shoot a still image; a zoom lever 42 that provides an instruction to increase or decrease an angle of view in the shooting performed by the image sensing portion 11; a setting button 43 that is composed of one or two or more buttons; and a cross key (four-direction key) 44. As shown in FIG. 3B, the cross key 44 is composed of four keys that are arranged on the right side, the upper side the left side and the lower side when seen from the center of the cross key 44 and that are keys 44[1], 44[2], 44[3] and 44[4], respectively.

When the image sensing device 1 is a digital video camera, it is also possible to make the shutter button 41 function as a button that provides an instruction to start or finish shooting a moving image. Operations performed by the user on the shutter button 41, the zoom lever 42, the setting button 43 and the cross key 44 are collectively referred to as a button operation. Information indicating the details of the button operation is referred to as button operation information.

The main control portion 19 comprehensively controls operations of the individual portions within the image sensing device 1 according to the details of the button operation, the details of a touch panel operation, which will be described later, or the like. The display control portion 20 controls the details of a display produced on the display portion 17.

A time stamp generation portion 21 generates time stamp information indicating a shooting time of a still image or a moving image, using a timer or the like incorporated in the image sensing device 1. A GPS information acquisition portion 22 receives a GPS signal transmitted from a GPS (global positioning system) satellite and thereby recognizes the present position of the image sensing device 1.

The operation modes of the image sensing device 1 include: a first operation mode in which an image (a still image or a moving image) can be shot and recorded; and a second operation mode in which the image (the still image or the moving image) recorded in the recording medium 15 is reproduced and displayed on the display portion 17 or an external display device. The operation mode switches between the individual operation modes according to the button operation.

In the first operation mode, a subject is periodically shot at a predetermined frame period, and image data indicating a shooting image sequence of the subject is obtained based on the output of the image sensing portion 11. An image sequence which a shooting image sequence is typical of refers to a collection of images arranged chronologically. Image data obtained in one frame period represents one sheet of an image.

The display portion 17 has a touch panel. FIG. 4 is an exploded view schematically showing the touch panel. The touch panel included in the display portion 17 is provided with: a display screen 51 that is formed with a liquid crystal display or the like; and a touch detection portion 52 that detects a position (a position to which a pressure is applied) on the display screen 51 touched by an operation member. The operation member is a finger, a pen or the like; in the following description, the operation member is assumed to be a finger. The finger described in the present specification refers to a finger of the user of the image sensing device 1.

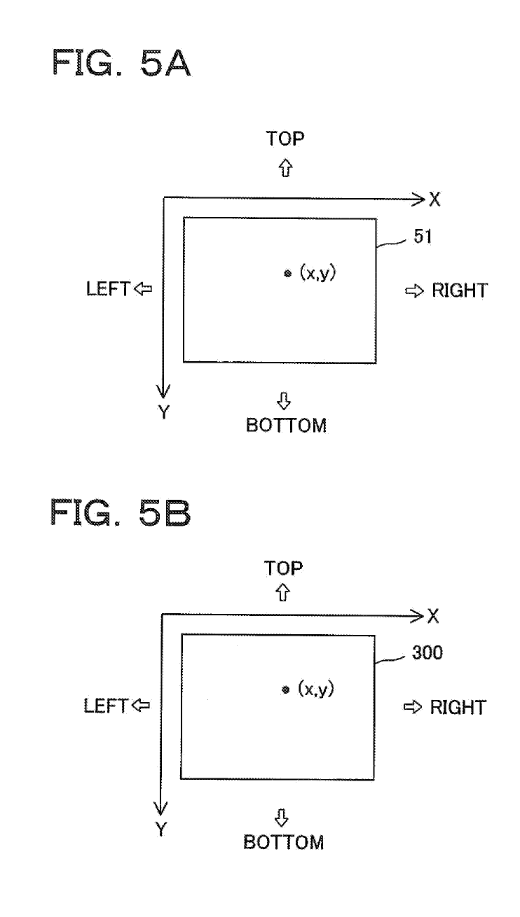

As shown in FIG. 5A, a position on the display screen 51 is defined as a position on a two-dimensional XY coordinate plane. As shown in FIG. 5B, in the image sensing device 1, an arbitrary two-dimensional image is also treated as an image on the XY coordinate plane. In FIG. 5B, a rectangle frame represented by reference numeral 300 indicates the outside frame of the two-dimensional image. The XY coordinate plane has, as coordinate axes, an X axis extending in a horizontal direction of the display screen 51 and the two-dimensional image 300 and a Y axis extending in a vertical direction of the display screen 51 and the two-dimensional image 300. Images described in the present specification are all two-dimensional images unless otherwise specified. The position of a noted point on the display screen 51 and the two-dimensional image 300 is represented by (x, y). The “x” represents an X axis coordinate value of the noted point, and also represents the horizontal position of the noted point on the display screen 51 and the two-dimensional image 300. The “y” represents a Y axis coordinate value of the noted point, and also represents the vertical position of the noted point on the display screen 51 and the two-dimensional image 300.

it is assumed that, in the display screen 51 and the two-dimensional image 300, as the value of the “x” which is the X axis coordinate value of the noted point is increased, the position of the noted point is moved to the right side (the right side on the XY coordinate plane) that is the positive side of the X axis whereas, as the value of the “y” which is the Y axis coordinate value of the noted point is increased, the position of the noted point is moved to the lower side (the lower side on the XY coordinate plane) that is the positive side of the Y axis. Hence, in the display screen 51 and the two-dimensional image 300, as the value of the “x” which is the X axis coordinate value of the noted point is decreased, the position of the noted point is moved to the left side (the left side on the XY coordinate plane) whereas, as the value of the “y” which is the Y axis coordinate value of the noted point is decreased, the position of the noted point is moved to the upper side (the upper side on the XY coordinate plane).

When the two-dimensional image 300 is displayed on the display screen 51 (when the two-dimensional image 300 is displayed using the entire display screen 51), an image in the position (x, y) on the two-dimensional image 300 is displayed in the position (x, y) on the display screen 51.

When the operation member touches the display screen 51, the touch detection portion 52 of FIG. 4 outputs, in real time, touch operation information indicating the position (x, y) touched by the operation member. The operation of touching the display screen 51 with the operation member is hereinafter referred to as the touch panel operation.

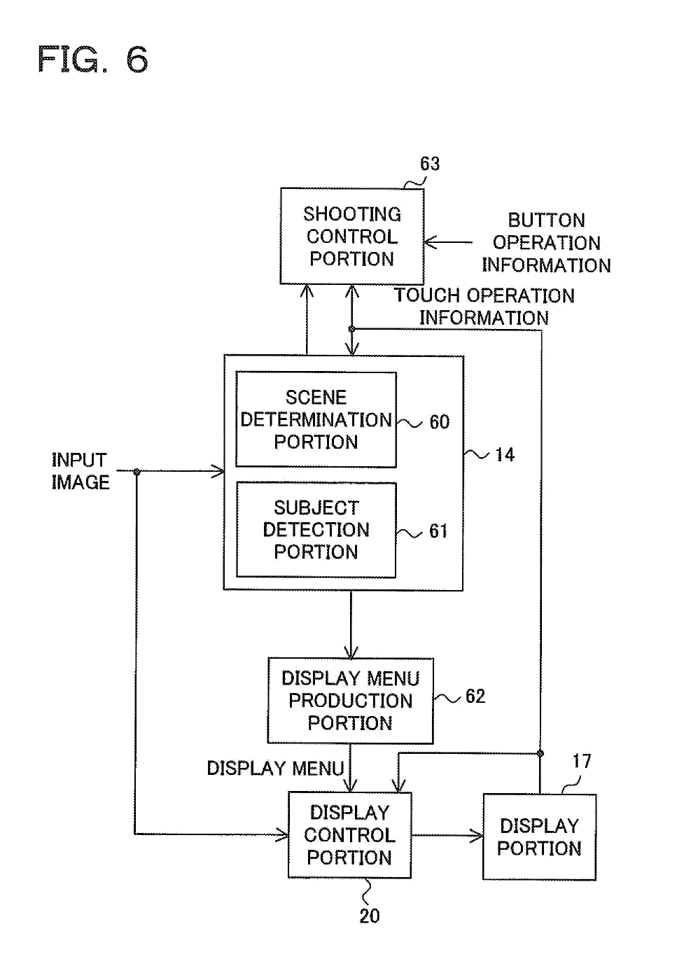

In the first embodiment, the operation of the image sensing device 1 in the first operation mode, in which a still image or a moving image can be shot, will be described below. FIG. 6 is a partial block diagram of the image sensing device 1 that is particularly involved in the operation of the first embodiment. A scene determination portion 60 and a subject detection portion 61 are provided in the image processing portion 14. A display menu production portion 62 and a shooting control portion 63 are provided in the main control portion 19. The display menu production portion 62 may be provided in the display control portion 20.

Image data on an input image is fed to the image processing portion 14 and the display control portion 20. The input image refers to a sheet of a still image indicated by RAW data obtained in one frame period or a still image obtained by performing predetermined image processing (such as demosaicing processing, noise reduction processing or the like) on the still image indicated by RAW data obtained in one frame period. In the first operation mode, input images are sequentially obtained at a predetermined frame period (that is, an input image sequence is obtained). The display control portion 20 can display the input image sequence as a moving image on the display screen 51.

The subject detection portion 61 performs, based on image data on the input image, subject detection processing that detects a subject included in the input image. The subject detection processing is performed to detect the type of subject on the input image.

The subject detection processing includes face detection processing that detects a face in the input image. In the face detection processing, based on the image data on the input image, a face region that is a region including a face portion of a person is detected and extracted from an image region in the input image. Face recognition processing may be included in the subject detection processing. In the face recognition processing, which of one or a plurality of registered persons who have been previously set is the person having the face extracted by the face detection processing from the input image is recognized. As the methods of performing the face detection processing and the face recognition processing, various methods are known, and the subject detection portion 61 can perform the face detection processing and the face recognition processing using an arbitrary method among methods including known methods.

Types of subjects that need to be detected in the subject detection processing are not only the face and the person. For example, in the subject detection processing, a car, a mountain, a tree, a flower, a sea, snow, a sky or the like in the input image can be detected. In order to detect them, it is possible to utilize various types of image processing such as analysis of brightness information, analysis of hue information, edge detection, outline detection, image matching and pattern recognition, and to utilize an arbitrary method among methods including known methods. For example, when the subject that needs to be detected is a car, the car on the input image can be detected either by detecting a tire on the input image based on image data on the input image or by performing image matching using image data on the input image and image data on images of cars previously prepared.

The scene determination portion 60 determines a shooting scene in the input image based on the image data on the input image. Processing for performing this determination is referred to as scene determination processing. A plurality of registered scenes are previously set in the scene determination portion 60. The registered scenes include, for example, a portrait scene that is a shooting scene in which a person is noted, a scenery scene that is a shooting scene in which scenery is noted, an animal scene that is a shooting scene in which an animal (such as a dog or a cat) is noted, a beach scene that is a shooting scene in which a sea is noted, a snow scene that is a shooting scene in which snow scenery is noted, a daytime scene that represents a daytime shooting state and a night view scene that represents the shooting state of a night view. Annuals described in the present specification refer to animals other than persons.

The scene determination portion 60 extracts, from image data on a noted input image, the image feature quantity that is useful for the scene determination processing, and thereby selects a shooting scene of the noted input image from the registered scenes. In this way, the shooting scene of the noted input image is determined. The shooting scene determined by the scene determination portion 60 is referred to as a determination scene. It is possible to perform the scene determination processing using the result of the subject detection processing performed by the subject detection portion 61. The operation of performing the scene determination processing using the result of the subject detection processing will be particularly described below.

The display menu production portion 62 produces a display menu based on the result of the subject detection processing and the result of the scene determination processing. When the display menu is produced by the display menu production portion 62, the display control portion 20 displays the display menu on the display screen 51 together with the input image. For example, an image obtained by superimposing the display menu on the input image is displayed on the display screen 51. The display control portion 20 utilizes the touch operation information to determine the position where the display menu is displayed.

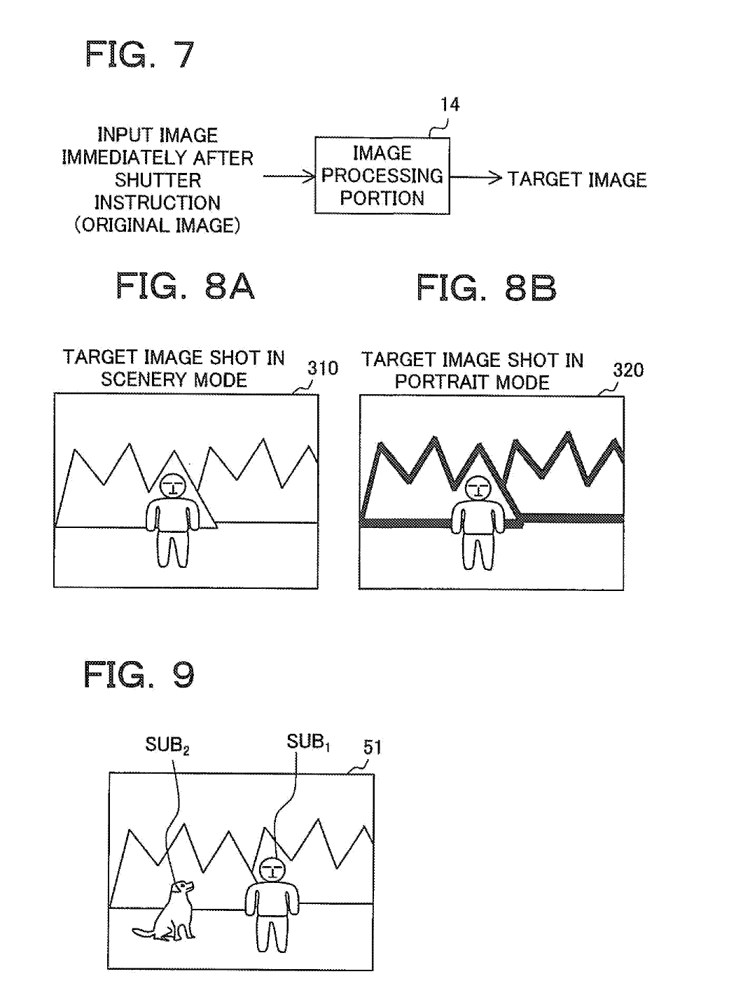

Based on the touch operation information and the button operation information, the shooting control portion 63 monitors whether or not a shutter instruction is performed by the user. When the shooting control portion 63 recognizes that the shutter instruction has been performed, a target image is shot in a shooting mode determined by the shooting control portion 63. Specifically, the shooting control portion 63 uses the image sensing portion 11 and the image processing portion 14 to generate image data on the target image. The target image refers to a still image based on an input image obtained immediately after the shutter instruction (see FIG. 7). The button operation of pressing the shutter button 41 is one of shutter instructions. As will be described in detail later, the shutter instruction can also be performed by conducting a specific touch panel operation.

In a shooting mode table (not shown) included in the shooting control portion 63, the first to N-th shooting modes are stored. Here, N is an integer equal to or greater than two (for example, N=10). The first to N-th shooting modes stored in the shooting mode table include a portrait mode, a scenery mode, a high-speed shutter mode, a beach mode, a snow mode, a daytime mode and a night view mode.

Based on all or part of the result of the subject detection processing, the result of the scene determination processing and the touch operation information and the button operation information, the shooting control portion 63 selects, from the first to N-th shooting modes, one shooting mode that is considered to be the optimum shooting mode as the shooting mode of the target image. The shooting mode selected here is hereinafter referred to as the selection shooting mode. Each of the shooting modes stored in the shooting mode table functions as a candidate shooting mode that is a candidate of the selection shooting mode; each of the shooting modes specifies shooting conditions of the target image.

The shooting conditions of the target image (in other words, the shooting conditions specified by the selection shooting mode) include: a shutter speed at the time of shooting of the input image that is the source of the target image (that is, the length of exposure time of the image sensor 33 for obtaining image data on the input image from the image sensor 33); an aperture value at the time of shooting of the input image that is the source of the target image; an ISO sensitivity at the time of shooting of the input image that is the source of the target image; and the details of image processing (hereinafter referred to as specific image processing) that is performed by the image processing portion 14 on the input image to produce the target image. The ISO sensitivity refers to the sensitivity specified by ISO (International Organization for Standardization); by adjusting the ISO sensitivity, it is possible to adjust the brightness (brightness level) of the input image. In fact, the amplification factor of the signal in the ATE 12 is determined according to the ISO sensitivity. The shooting control portion 63 controls the image sensing portion 11, the AFT 12 and the image processing portion 14 under the shooting conditions specified by the selection shooting mode so as to obtain image data on the input image and the target image.

As shown in FIG. 7, the image processing portion 14 performs the specific image processing on the input image (hereinafter referred to as an original image) obtained immediately after the shutter instruction, and thereby generates the target image. No specific image processing may be performed depending on the selection shooting mode; in this case, the target image is the original image itself.

With respect to the first to N-th shooting modes described above, shooting conditions specified by the i-th shooting mode and shooting conditions specified by the j-th shooting mode differ from each other. This generally holds true for an arbitrary integer i and an arbitrary integer j that differ from each other (where i≦N and j≦N), but the shooting conditions of N_{A} shooting modes included in the first to N-th shooting modes can be the same as each other (N_{A} is an integer less than N). For example, when N=10, the shooting conditions of the first to ninth shooting modes differ from each other, but the shooting conditions of the ninth and the tenth shooting modes can be the same as each other (in this case, N_{A}=2).

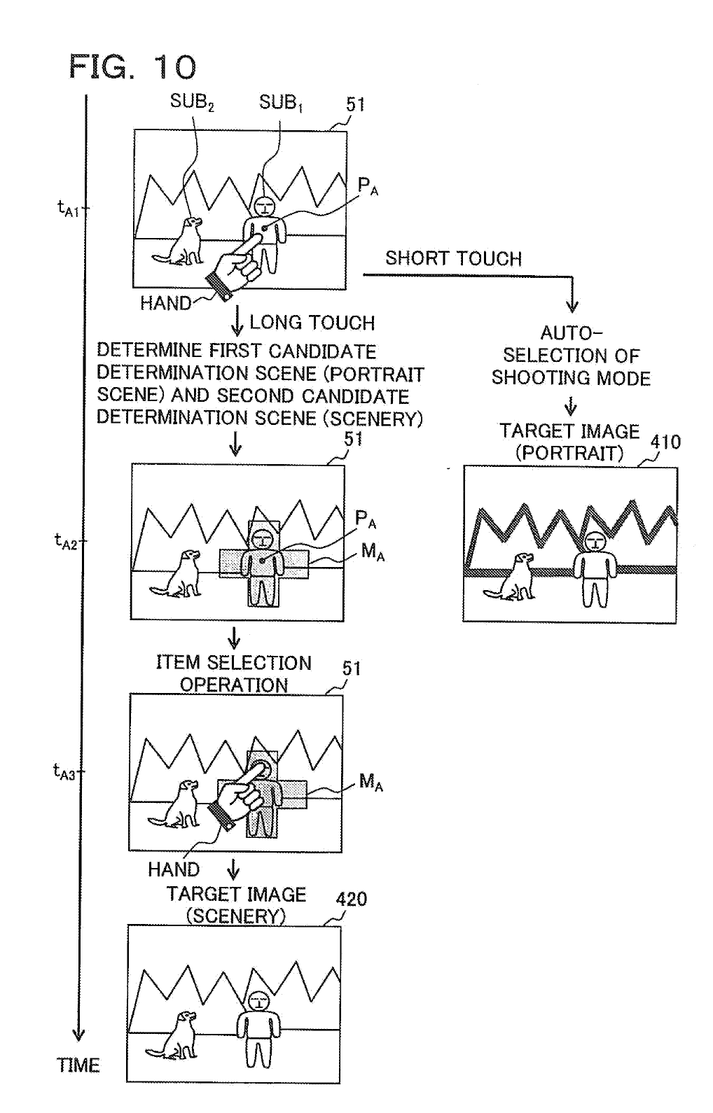

Specifically, for example, the shooting control portion 63 varies the aperture value between the portrait mode and the scenery mode, and thus makes the depth of field of the target image shot in the portrait mode narrower than the depth of field of the target image shot in the scenery mode. An image 310 of FIG. 8A represents a target image shot in the scenery mode; an image 320 of FIG. 8B represents a target image shot in the portrait mode. The target images 310 and 320 are obtained by shooting the same subject. However, based on a difference between the depths of field, the person and the scenery appear clear in the target image 310 whereas the person appears clear but the scenery appears blurred in the target image 320. In FIG. 8B, the thick outline of the mountain is used to represent blurring (the same is true on a target image 410 shown in FIG. 10 or the like, which will be described later).

The shooting control portion 63 may make the depth of field in the portrait mode narrower than that in the scenery mode by performing the following procedure: the same aperture value is used in the portrait mode and the scenery mode whereas the specific image processing is varied between the portrait mode and the scenery mode. Specifically, for example, when the shooting mode of the target image is the scenery mode, the specific image processing performed on the original image does not include background blurring processing whereas, when the shooting mode of the target image is the portrait mode, the specific image processing performed on the original image includes the background blurring processing. The background blurring processing refers to processing (such as spatial domain filtering using a Gaussian filter) that blurs an image region other than an image region where image data on a person is present in the original image. The difference between the specific image processing including the background blurring processing and the specific image processing excluding the background blurring processing as described above also allows the depth of field to be substantially varied between the target image in the portrait mode and the target image in the scenery mode.

Moreover, for example, when the shooting mode of the target image is the scenery mode, the specific image processing performed on the original image may not include skin color correction whereas, when the shooting mode of the target image is the portrait mode, the specific image processing performed on the original image may include skin color correction. The skin color correction is processing that corrects the color of a part of the image of a person's face which is classified into skin color.

For example, in the high-speed shutter mode, the shutter speed is set faster than in the portrait mode or the like (that is, the length of exposure time of the image sensor 33 for obtaining image data on the target image from the image sensor 33 is set short). For example, in the beach mode, processing that corrects the color of an image portion having the hue of a sea on the original image is included in the specific image processing. Furthermore, it is possible to set the shooting conditions of each shooting mode from various points of view; it is also possible to utilize a known arbitrary setting method to set the shooting conditions of each shooting mode.

First Shooting Operation Example

A first shooting operation example of the image sensing device 1 will now be described with reference to FIGS. 9 and 10. In the first shooting operation example, it is assumed that a person SUB₁ which is a first subject, a dog SUB₂ which is a second subject and a mountain arranged behind the person SUB₁ and the dog SUB₂ are included in the shooting range of the image sensing portion 11. For convenience, this assumption is referred to as an assumption α. FIG. 9 shows the display screen 51 under the assumption α. How the display screen 51 is changed and an example of the target image obtained when the user shoots the target image under the assumption α are shown in FIG. 10. A time t_{Ai+1} is assumed to be a time that is behind a time t_{Ai}. The “i” is an integer. In FIG. 10, the picture of a hand represented by symbol HAND indicates the hand of the user. The hand HAND is not an image displayed on the display screen 51 but is the actual hand of the user.

At a time t_{A1}, the user touches a position P_{A} on the display screen 51 (it is assumed that the display screen 51 has not been touched by a finger at all before the time t_{A1}). A touch refers to an operation of touching a specific portion on the display screen 51 by a finger. When the position P_{A} is touched for a relatively short period of time, a touch starting at the time t_{A1} is determined to be a short touch whereas when the position P_{A} is touched for a relatively long period of time, the touch starting at the time t_{A1} is determined to be a long touch.

Specifically, when the touch starting at the time t_{A1} is cancelled by a time (t_{A1}+Δt), the touch starting at the time t_{A1} is determined to be the short touch whereas when the touch starting at the time t_{A1} continues until the time (t_{A1}+Δt), the touch starting at the time t_{A1} is determined to be the long touch. The Δt is a predetermined value in time (where Δt>0). The time (t_{A1}+Δt) indicates a time that is a time period Δt behind the time t_{A1}. Based on the touch operation information, the main control portion 19 can determine whether a touch performed on the display screen 51 is the short touch or the long touch.

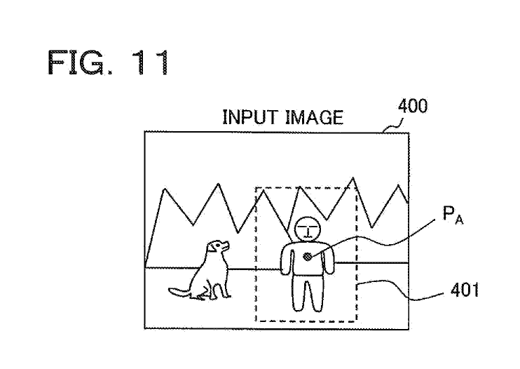

On the other hand, when the position P_{A} is touched, the subject detection portion 61 sets the position P_{A} to a reference position, and performs, based on image data on the input image at the present tune, the subject detection processing for detecting the type of subject in the reference position and the type of vicinity subject around the reference position. The subject in the reference position refers to a subject having image data in the reference position; the vicinity subject around the reference position refers to a subject that is arranged in the vicinity of the subject in the reference position. For example, as shown in FIG. 11, the subject detection portion 61 sets, on the input image 400, a determination region 401 whose center is located in the reference position P_{A}, detects the type of subject present within the determination region 401 based on image data within the determination region 401 and thereby detects the types of subject and vicinity subject around the reference position. It is not mandatory to detect the type of vicinity subject around the reference position; the vicinity subject around the reference position may not be detected. The input image 400 is either an input image shot at the time t_{A1} or an input image shot immediately after the time t_{A1}. The determination region 401 is part of the entire image region of the input image 400 (the same is true on the other determination regions described later). Although an arbitrary determination region which the input image 400 is typical of may be formed in a shape other than a rectangle, it is assumed to be rectangular.

In the first shooting operation example, as shown in FIG. 10, image data on the person SUB₁ is present in the position P_{A}. Hence, the type of subject in the reference position is determined to be the person. It is assumed that the type of vicinity subject around the reference position is determined to be the mountain.

When the touch starting at the time t_{A1} is the short touch, the finger is separated from the display screen 51 at a time that is behind the time t_{A1} but ahead of the time (t_{A1}+Δt). The shooting control portion 63 recognizes the separation of the finger based on the touch operation information, and immediately performs, along with the scene determination portion 60, auto-selection of the shooting mode to make the target image shot (in this case, the operation of separating the finger in contact with the display screen 51 from the display screen 51 functions as the shutter instruction).

In the auto-selection of the shooting mode, the scene determination processing is performed based on the type of subject in the reference position, the selection shooting mode is determined from the result of the scene determination processing and then the image sensing portion 11 and the image processing portion 14 are made to shoot the target image in the selection shooting mode (are made to produce image data on the target image). When the type of subject in the reference position is the person, the determination scene is set at the portrait scene and the selection shooting mode is set at the portrait mode by the auto-selection of the shooting mode. Consequently, it is possible to obtain the target image 410 that has been shot in the portrait mode. Unlike the first shooting operation example corresponding to FIG. 10, if the type of subject in the reference position is the dog, the determination scene is set at the animal scene and the selection shooting mode is set at the high-speed shutter mode by the auto-selection of the shooting mode. Consequently, it is possible to obtain the target image that has been shot in the high-speed shutter mode.

When the touch starting at the time t_{A1} is the long touch, the scene determination portion 60 determines first and second candidate determination scenes, and a display menu M_{A} is displayed along with the input image at the present time on the display screen 51 at a time t_{A2} that is behind the time (t_{A1}+Δt) (the first and second candidate determination scenes will be described later). The display menu M_{A} is displayed in such a position that its center is located in the reference position P_{A}. For example, as shown in FIG. 10, the display menu M_{A} is displayed by being superimposed on the input image at the present time. In this case, it is preferable to superimpose the display menu M_{A} utilizing alpha blending or the like such that an image of a portion of the input image on which the display menu M_{A} is superimposed becomes visibly transparent.

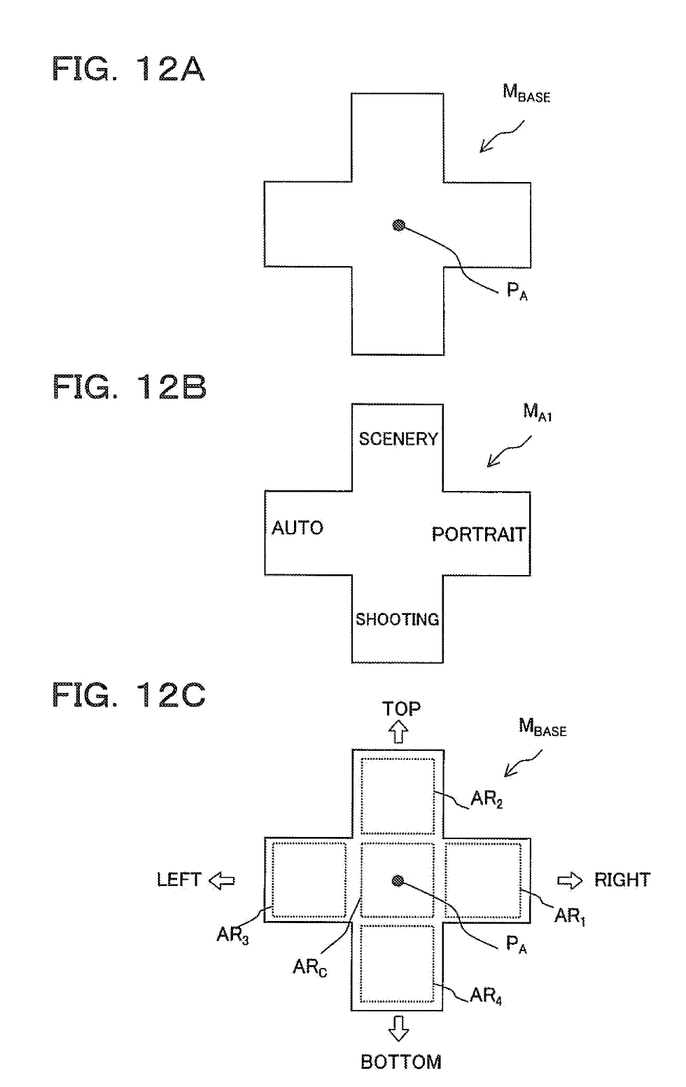

The display menu M_{A} is produced by the display menu production portion 62 of FIG. 6. FIG. 12A shows a basic icon M_{BASE} that is a component of the display menu M_{A}. FIG. 12B shows the display menu M_{A1} as the display menu M_{A} that is actually displayed at the time t_{A2}. FIG. 12C is a diagram showing the configuration of the basic icon M_{BASE}.

The basic icon M_{BASE} has an outside shape obtained by coupling a region AR_{C} and regions AR₁ to AR₄ that are each rectangular. With the region AR_{C} arranged in the center, the regions AR₁, AR₂, AR₃ and AR₄ are coupled to the right side, the upper side, the left side and the lower side of the region AR_{C}, respectively. The center of the region AR_{C} is arranged in the reference position P_{A}. The display menu M_{A} is formed by superimposing a word, a figure or a combination thereof indicating an item to be selected, on each of the regions AR₁ to AR₄ in the basic icon M_{BASE}. For specific description, it is now assumed that the item to be selected is represented by a word. The word representing the item to be selected is determined based on the result of the scene determination processing using the result of the subject detection processing described previously.

A determination scene that is determined from image data within the determination region with respect to the reference position is particularly referred to as a candidate determination scene. A plurality of candidate determination scenes are determined. In the first shooting operation example corresponding to FIG. 10, since the type of subject in the reference position is determined to be the person, the scene determination portion 60 determines that the first candidate determination scene is the portrait scene corresponding to the person. Moreover, since the type of vicinity subject around the reference position is determined to be the mountain, the scene determination portion 60 determines that the second candidate determination scene is the scenery scene corresponding to the mountain. Based on the details of these determinations, the display menu production portion 62 sets words to be displayed in the regions AR₁ and AR₂, of the display menu M_{A} to a “portrait” and a “scenery”, respectively. In other words, the first and second candidate determination scenes are made to correspond to the regions AR₁ and AR₂, and the words corresponding to the first and second candidate determination scenes are displayed in the AR₁ and AR₂. On the other hand, words displayed in the AR₃ and AR₄ in the display menu M_{A1} are set at an “auto” and a “shooting”, respectively. The regions AR₁ to AR₄ are respectively regions in which first to fourth items to be selected are displayed.

In the example of FIG. 10, although the display menu M_{A1} of FIG. 12B is actually displayed on the display screen 51 at the time t_{A2}, instead of the display menu M_{A1}, only the basic icon M_{BASE} is shown in FIG. 10 so that the figure is prevented from being complicated. Although the display screen 51 is actually touched by the finger at the time t_{A2}, the finger touching the display screen 51 is not shown in FIG. 10 for convenience of illustration. The display menu M_{A1} continues to be displayed until an item selection operation, which will be described later, is performed.

At a time t_{A3} that is behind the time t_{A2}, the user performs the item selection operation. The item selection operation refers to an operation of selecting any of the first to fourth items to be selected in the display menu (M_{A1} in this example) (in other words, an operation of selecting any of the regions AR₁, to AR₄). Based on the touch operation information, the shooting control portion 63 or the main control portion 19 determines whether or not the item selection operation is performed.

The item selection operation of selecting the i-th item to be selected is any one of the following operations:

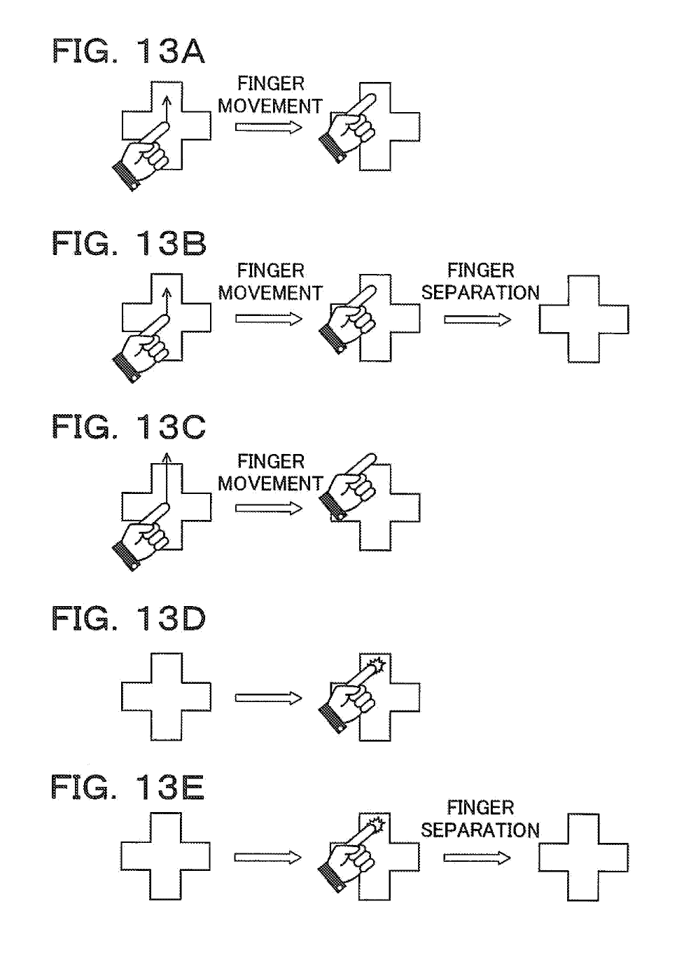

an operation of moving the finger from the reference position P_{A}, which is the starting point, to the region AR₁ with the finger in contact with the display screen 51, as shown in FIG. 13A;

an operation of moving the finger from the reference position P_{A}, which is the starting point, to the region AR₁ with the finger in contact with the display screen 51, and then separating the finger from the display screen 51 as shown in FIG. 13B; and

an operation of moving the finger from the reference position P_{A}, which is the starting point, to the region AR₁ with the finger in contact with the display screen 51, and further moving the finger to the outside of the region AR₁, along the direction pointing from the reference position P_{A} to the region AR₁, with the finger in contact with the display screen 51, as shown in FIG. 13C.

An operation of temporarily separating the finger in contact with the display screen 51 from the display screen 51 at the time t_{A2} and then touching the region AR₁, as shown in FIG. 13D, may be the item selection operation of selecting the i-th item to be selected. An operation of temporarily separating the finger in contact with the display screen 51 from the display screen 51 at the time t_{A2}, then touching the region AR, and thereafter separating the finger from the display screen 51, as shown in FIG. 13E, may also be the item selection operation of selecting the i-th item to be selected.

The button operation performed on the cross key 44 may also function as the item selection operation (see FIGS. 3A and 3B). Specifically, with the display menu M_{A1} displayed, an operation of pressing a key 44[i] may be the item selection operation of selecting the i-th item to be selected.

The item to be selected that is selected in the item selection operation is referred to as a selection item. Since the first to fourth items to be selected are respectively items to be selected that correspond to the regions AR₁ to AR₄ in the display menu M_{A1}, when the i-th item to be selected is selected as the selection item, the target image is shot in the shooting mode corresponding to the region AR₁. Specifically, when the shooting control portion 63 recognizes that the item selection operation is performed at the time t_{A3}, the shooting control portion 63 makes the image sensing portion 11 and the image processing portion 14 shoot the target image in the shooting mode corresponding to the selection item (makes them produce image data on the target image). For example, when the first item to be selected is selected as the selection item with the display menu M_{A1} of FIG. 11B displayed, the target image is shot in the shooting mode corresponding to the portrait scene that is the first candidate determination scene, that is, the portrait mode whereas when the second item to be selected is selected as the selection item, the target image is shot in the shooting mode corresponding to the scenery scene that is the second candidate determination scene, that is the scenery mode. FIG. 10 shows, as an example, a case where the second item to be selected corresponding to the region AR₂ is selected as the selection item; the second item to be selected is selected as the selection item, and consequently, a target image 420 shot in the scenery mode is obtained.

When the third item to be selected is selected as the selection item, the shooting control portion 63 performs the auto-selection of the shooting mode to make the target image shot (consequently, the same target image as in the case of the short touch is obtained).

When the fourth item to be selected is selected as the selection item, the shooting control portion 63 uses, as the selection shooting mode, a shooting mode based on an entire image scene determination result, and thereby makes the target image shot. The entire image scene determination result refers to the result of the scene determination processing that is performed using image data on the entire input image. Therefore, when the determination scene of the entire image scene determination result is the portrait scene, if the fourth item to be selected is selected as the selection item, the shooting control portion 63 makes the target image shot in the portrait mode corresponding to the portrait scene.

[A second shooting operation example]

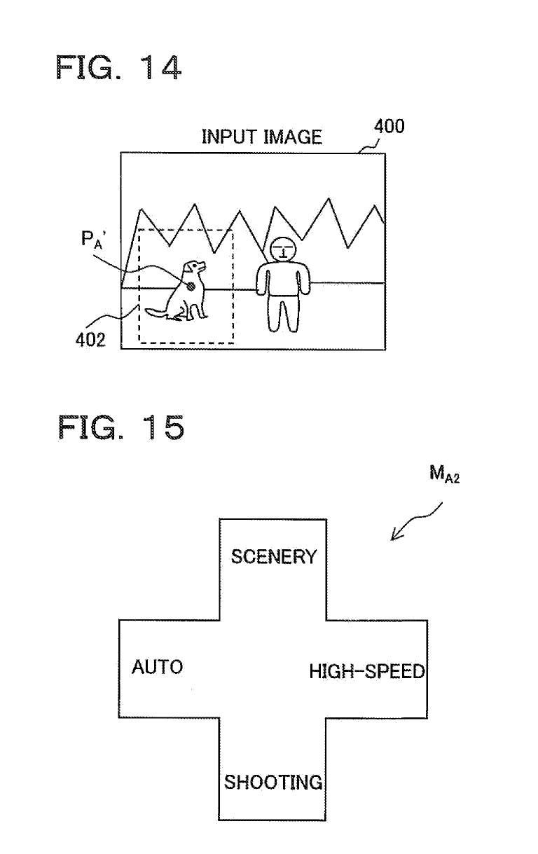

A second shooting operation example obtained by varying the first shooting operation example will be described. In the second shooting operation example, it is assumed that, instead of the position P_{A}, a position P_{A}′ where image data on the dog SUB₂ is present is touched at the time t_{A1}, and consequently, the position P_{A}′ is set at the reference position. In this case, as shown in FIG. 14, the subject detection portion 61 sets, on the input image 400, a determination region 402 whose center is located in the reference position P_{A}′, detects the type of subject present within the determination region 402 based on image data within the determination region 402 and thereby detects the types of subject and vicinity subject around the reference position P_{A}′. The image data on the dog SUB₂ is present in the reference position P_{A}′. Hence, the type of subject in the reference position P_{A}′ is determined to be the dog. Moreover, it is assumed that the type of vicinity subject around the reference position is determined to be the mountain. Therefore, when the touch starting at the time t_{A1} is the long touch, instead of the display menu M_{A1} of FIG. 11B, a display menu M_{A2} of FIG. 15 is produced and displayed at the time t_{A2} and the subsequent times.

In the second shooting operation example. since the type of subject in the reference position P_{A}′ is determined to be the dog, the scene determination portion 60 determines that the first candidate determination scene is the animal scene. Moreover, since the type of vicinity subject around the reference position is determined to be the mountain, the scene determination portion 60 determines that the second candidate determination scene is the scenery scene. Based on the details of these determinations, the display menu production portion 62 sets words to be displayed in the regions AR₁ and AR₂ of the display menu M_{A2} to a “high-speed” and a “scenery”, respectively. In other words, the first and second candidate determination scenes are made to correspond to the regions AR₁ and AR₂, and the words corresponding to the first and second candidate determination scenes are displayed in the AR₁ and AR₂. On the other hand, words displayed in the AR₃ and AR₄ in the display menu M_{A2} are set at an “auto” and a “shooting”, respectively.

When the first item to be selected is selected as the selection item with the display menu M_{A2} of FIG. 15 displayed, the target image is shot in the shooting mode corresponding to the animal scene that is the first candidate determination scene, that is, the high-speed shutter mode whereas when the second item to be selected is selected as the selection item, the target image is shot in the shooting mode corresponding to the scenery scene that is the second candidate determination scene, that is, the scenery mode. The operation performed when the third or fourth item to be selected is selected as the selection item is the same as in the first shooting operation example.

[Operational flow chart]

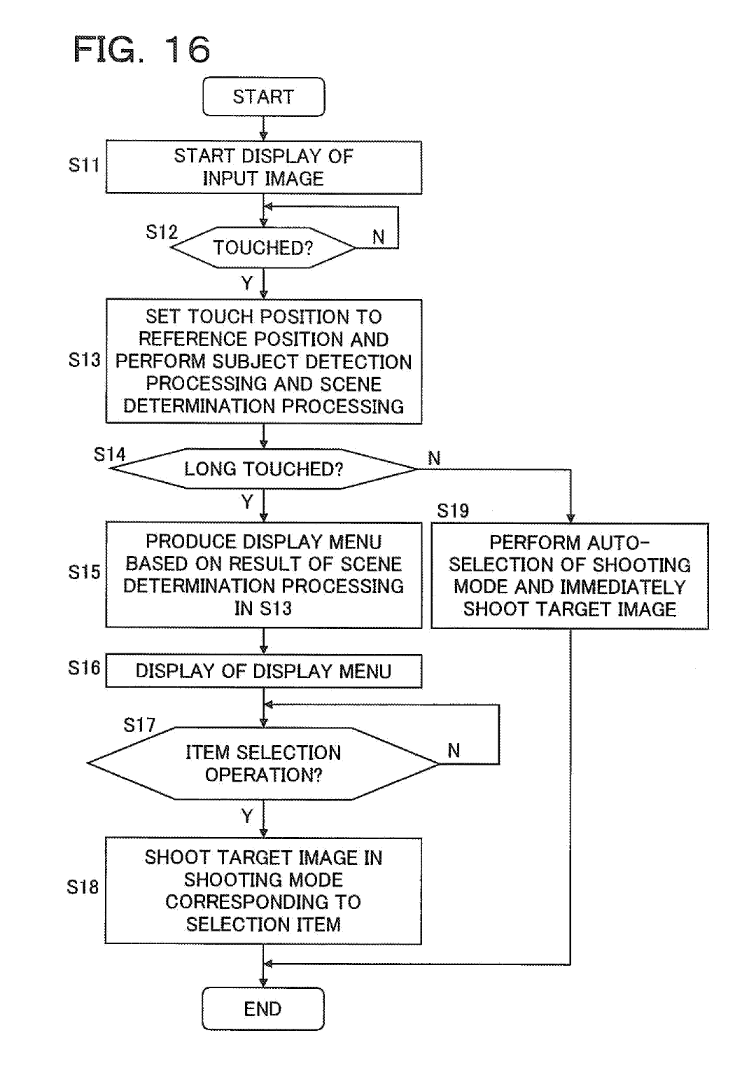

A procedure for ate operation of obtaining a sheet of a target image will now be described with reference to FIG. 16. FIG. 16 is a flowchart showing the procedure of this operation.

In the first operation mode in which a still image can be shot, input images are sequentially obtained at the predetermined frame period, and, in step S11, an input image sequence is displayed as a moving image. The processing that displays the input image sequence as the moving image continues until the target image is shot in step S18 or S19, and, after the target image is shot in step S18 or S19, the process returns to step S11.

In step S12 subsequent to step S11, the main control portion 19 determines whether or not the display screen 51 is touched based on the touch operation information (that is, whether or not the display screen 51 is touched by the finger). If the display screen 51 is touched, the process moves from step S12 to step S13 whereas if the display screen 51 is not touched, the determination processing in step S12 is repeated.

In step S13, the image processing portion 14 and the main control portion 19 set the touched position to the reference position. In step S13, the subject detection portion 61 performs the subject detection processing for detecting the type of subject in the reference position and the type of vicinity subject around the reference position, and furthermore the scene determination portion 60 performs the scene determination processing using the result of the subject detection processing, and thereby determines the first and second candidate determination scenes described previously.

After the processing in step S13 is performed or at the same dine when the processing in step S13 is performed, the processing in step S14 is performed. In step S14, the main control portion 19 determines, based on the touch operation information, whether or not a touch performed on the display screen 51 is the long touch, and, if the touch is the long touch, the process moves from step S14 to step S15 whereas if the touch is the short touch. the process moves from step S14 to step S19.

In step S15, the display menu production portion 62 produces the display menu M_{A} based on the result of the scene determination processing in step S13, and, in step S16 subsequent to step S15, the display menu M_{A} is displayed on the display screen 51 under the control of the display control portion 20. As described previously, the display menu M_{A} is displayed along with the input image at the present time, and the display of the display menu M_{A} is continued until the item selection operation is performed.

In step S17, the shooting control portion 63 (or the main control portion 19) determines, based on the touch operation information, whether or not the item selection operation is performed, and, only if the item selection operation is determined to be performed, the process moves from step S17 to step S18. In step S18, the shooting control portion 63 makes the image sensing portion 11 and the image processing portion 14 shoot the target image in the shooting mode corresponding to the selection item (make them produce image data on the target image). Hence, the item selection operation functions as the shutter instruction. On the other hand, in step S19, the shooting control portion 63 performs the auto-selection of the shooting mode, and immediately makes the target image shot in the shooting mode determined by the auto-selection. Image data on the target image obtained in step S18 or S19 is recorded in the recording medium 15.

A subject (subject at a portion touched by the user) in a position specified by the user can be considered to be a subject that is noted by the user. Hence, in the present embodiment, the type of subject in the specified position is detected, and the details of the display menu are correspondingly changed according to the result of the detection. For example, as described previously, when the subject in the specified position is a person, an item to be selected for providing an instruction to shoot in the portrait mode is included in the display menu, or when the subject in the specified position is an animal, an item to be selected for providing an instruction to shoot in the high-speed shutter mode is included in the display menu.

When the subject in the specified position is considered to be a subject that is noted by the user an item to be selected thereof is probably highly likely to be selected by the user after the operation of inputting the specified position. Hence, the production and the display of the display menu as described above probably facilitate enhancement of operability. For example, when the user desires to use the high-speed shutter mode suitable for shooting an animal, if as in a method disclosed in JP-A-H11-164175, only a shutter button, a zoom-up button, a zoom-down button and the like are included in a display menu (or a display of the display menu itself is not present), the user performs a first operation of displaying a menu for selecting a shooting mode from a plurality of registered modes, then performs a second operation of selecting the high-speed shutter mode from the menu displayed by the first operation and thereafter needs to perform a shutter instruction operation. By contrast, in the present embodiment, since an animal is touched as the noted subject and thus the display menu M_{A2} of FIG. 15 is automatically displayed through the subject detection processing, only a simple operation of, for example, sliding the finger to the displayed position corresponding to the high-speed shutter mode is thereafter performed, and thus it is possible to finish providing an instruction to shoot in the high-speed shutter mode.

Since the time period during which the finger is in contact with the display screen 51 is reduced, and thus the user can provide an instruction to immediately shoot the target image, a chance to press the shutter is prevented from being missed. Although the shooting of the target image can also be triggered by the touching of the display screen 51 with the finger, the housing of the image sensing device 1 shakes and this likely results in a binned image at the moment of the touching and in a certain period of time after the touching. By contrast, in the present embodiment, when the shutter instruction is performed by the short touch, the shooting of the target image is triggered by the separation of the finger from the display screen 51 (the separation of the finger from the display screen 51 is detected, and then the exposure of the input image that is the source of the target image is started). Thus, the blurring of the target image is reduced. The same is true on the shutter instruction performed by the item selection operation of FIGS. 13B and 13E. The amount of camera shake produced when the finger slides on the display screen 51 is generally smaller than that produced at the moment when the finger touches the display screen 51. Therefore, the blurring of the target image is expected to be reduced on the shutter instruction performed by the item selection operation of FIG. 13A or 13C.

Although, in the example described above, only when the finger is in contact with the display screen 51 for a relatively long period of time, the display menu is produced and displayed, the display menu may be produced and displayed regardless of the time period during which they are in contact with each other. In other words, after the processing in step S13 of FIG. 16, the process may always move to step S15 without branch processing in step S14 being performed.

Although, in the example described above, the first and second candidate determination scenes corresponding to the first and second items to be selected are made to correspond to the regions AR₁ and AR₂, respectively, and the third and fourth items to be selected corresponding to the words “auto” and “shooting” are made to correspond to the regions AR₁ and AR₄, respectively, correspondence relationships between the first to fourth items to be selected, and the regions AR₁. to AR₄ are not limited to this.

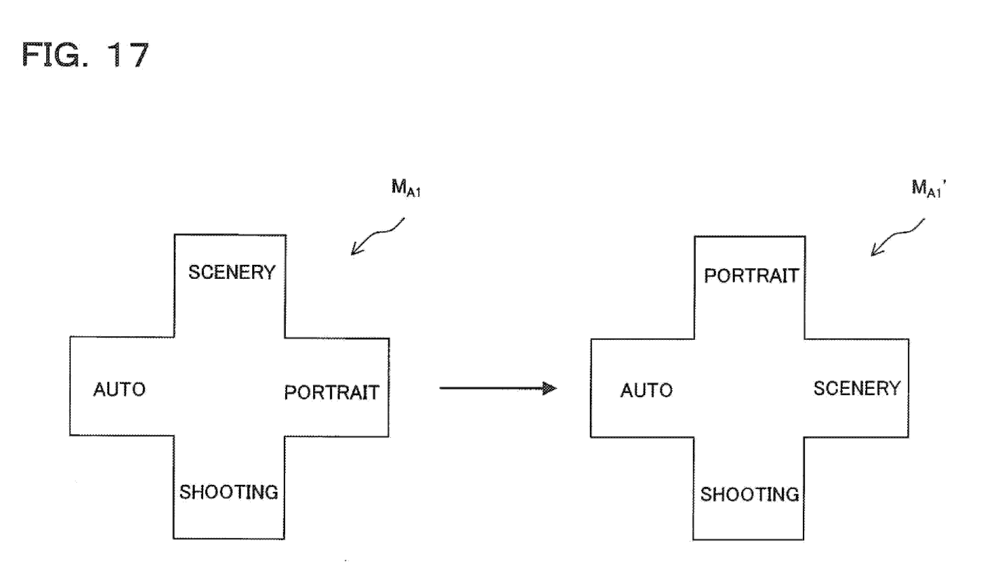

For example, based on the history of item selection by the user these correspondence relationships may be changed. Specifically, for example, it is assumed that, when the first and second candidate determination scenes are the “portrait scene” and the “scenery scene” respectively, and the display menu M_{A1} is displayed, the item selection operation that selects the region AR₂ corresponding to the “scenery” is frequently performed. In consideration of the shape of the housing of the image sensing device 1 and the like, it is assumed that the item selection operation that selects the region AR₁ is performed more easily than the item selection operation that selects the region AR₂. The main control portion 19 stores the history of the item selection operations in a history memory (not shown) within the image sensing device 1. After the storage of the history, when the first and second candidate determination scenes are determined to be the “portrait scene” and the “scenery scene”, respectively, as shown in FIG. 17, the display menu M_{A} displayed on the display screen 51 may be changed from the display menu M_{A1} to the display menu M_{A1}′. In the display menu M_{A1}′, the word “portrait” corresponding to the first candidate determination scene is shown in the region AR₂, and the word “scenery” corresponding to the second candidate determination scene is shown in the region AR₁ (in the other respects, the display menus M_{A1} and M_{A1}′ are the same as each other). When the display menu M_{A1}′ is displayed, if the item selection operation that selects the first item to be selected is performed, the target image is shot in the scenery mode whereas, if the item selection operation that selects the second item to be selected is performed, the target image is shot in the portrait mode.

Although, in the example described above, when the long touch is performed, the first and second candidate determination scenes are determined by the scene determination portion 60 based on image data within the determination region, and two items to be selected corresponding to the first and second candidate determination scenes are included in the display menu M_{A}, the number of candidate determination scenes determined based on the image data within the determination region may be one or may he three or more. When the number is one, one item to be selected corresponding to the first candidate determination scene is included in the display menu M_{A} whereas, when the number is three, three items to be selected corresponding to the first to third candidate determination scenes are included in the display menu M_{A} (the same is true when the number is four or more).

### Second Embodiment

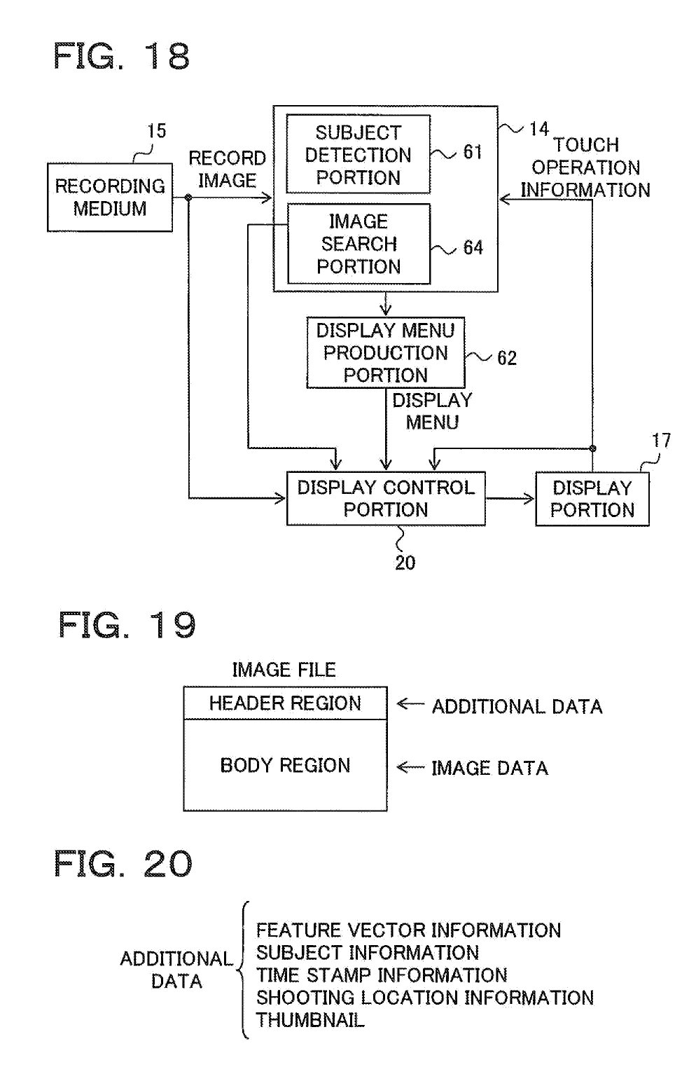

A second embodiment of the present invention will be described. The image sensing device of the second embodiment is the image sensing device 1, as in the first embodiment. The description in the first embodiment is also applied to what is not particularly described in the second embodiment. FIG. 18 is a partial block diagram of the image sensing device 1 that is particularly involved in the operation of the second embodiment. The subject detection portion 61 and the display menu production portion 62 are the same as those shown in FIG. 6. In the second embodiment, since an image search portion 64 within the image processing portion 14 significantly functions, the image search portion 64 is shown in FIG. 18.

In the second embodiment, image data on P sheets of still images is assumed to be recorded in the recording medium 15. P is an integer equal to or greater than two. Each of the still images recorded in the recording medium 15 is also referred to as a record image. Image data on an arbitrary record image is fed from the recording medium 15 to the image processing portion 14 and the display control portion 20. In the second embodiment, the record image functions as the input image.

In FIG. 19, the structure of an image file is shown. The recording control portion 16 of FIG. 1 can produce one image file for one still image or one moving image within the recording medium 15. The structure of the image file can be made to conform to an arbitrary standard. The image file is composed of: a body region in which image data itself on a still image or a moving image or compressed data thereof needs to be stored; and a header region in which additional data needs to be stored.

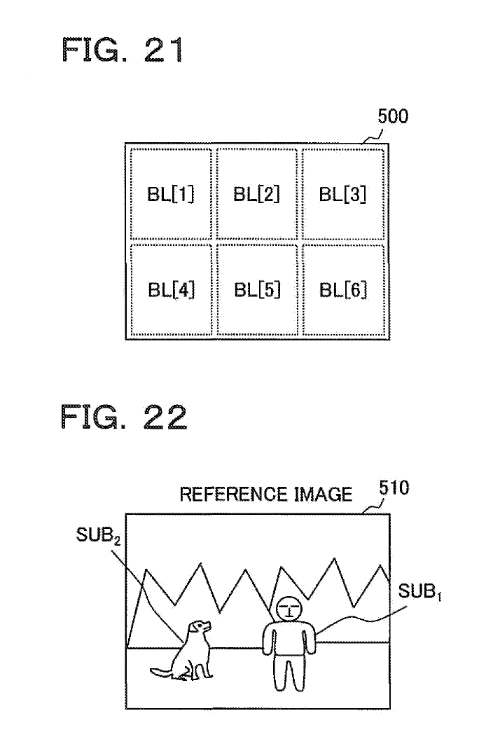

As shown in FIG. 20, it is possible to include, in additional data on a certain still image, feature vector information indicating the feature vector of the still image, subject information indicating the type of subject included in the still image, time stamp information indicating the shooting time (that is, a time when the still image is generated by shooting) of the still image and shooting location information indicating a shooting location (that is, a location where the still image is generated by shooting) of the still image, in the following description, it is assumed that all the information is included in the additional data on the still image. The additional data on the certain still image also includes image data on a thumbnail of the still image, file name information and ISO sensitivity information.

In order for the additional data to be described specifically, an arbitrary sheet of a still image that needs to be stored in one image file is represented by reference numeral 500. The feature vector information that needs to be included in the additional data on the still image 500 is produced based on feature vector derivation processing on the still image 500. The feature vector derivation processing is performed by the image processing portion 14.

For example, as shown in FIG. 21, the image processing portion 14 divides the entire image region of the still image 500 into six parts and thereby sets, within the entire image region of the still image 500, six division blocks BL[1] to BL[6] that should be called six division image regions, and performs the feature vector derivation processing on each of the division blocks and thereby derives a feature vector of each of the division blocks. The number of division blocks is set at six by way of example; the number can be set at a number other than six. An image region or a division block from which the feature vector is derived is referred to as a feature evaluation region. The feature vector represents the feature of an image within the feature evaluation region, and is the image feature quantity corresponding to the shape, color and the like of an object in the feature evaluation region. An arbitrary feature vector derivation method among methods including known methods can be used for the feature vector derivation processing. For example, the image processing portion 14 can derive the feature vector of the feature evaluation region using a method specified by MPEG (moving picture experts group) 7 The feature vector is a J-dimensional vector that is arranged in a J-dimensional feature space (J is an integer equal to or greater than two).

The subject information that needs to be included in the additional data on the still image 500 is produced based on the subject detection processing that is performed by the subject detection portion 61 on the still image 500. A method of performing the subject detection processing is the same as described in the first embodiment. For example, when a person is detected from the still image 500, subject information indicating the presence of a person within the still image 500 is included in the additional data; when a dog is detected from the still image 500, subject information indicating the presence of a dog within the still image 500 is included in the additional data; and when a person and a dog are detected from the still image 500, subject information indicating the presence of a person and a dog within the still image 500 is included in the additional data. Furthermore, when the subject detection processing includes the face recognition processing, if an i-th registered person is detected from the still image 500, subject information indicating the presence of the i-th registered person within the still image 500 is included in the additional data.

The time stamp information and the shooting location information that need to be included in the additional data on the still image 500 are produced by the time stamp generation portion 21 and the GPS information acquisition portion 22 shown in FIG. 1. The thumbnail of the still image 500 is an image obtained by reducing the size of the still image 500, and is generally produced by thinning out the pixels of the still image 500. The above additional data is produced when the image file of the still image 500 is produced within the recording medium 15.

In the second embodiment an operation of the image sensing device 1 in the second operation mode will be described below unless otherwise specified. As described previously, in the second operation mode, an image (a still image or a moving image) recorded in the recording medium 15 can be displayed on the display portion 17. In the second operation mode, the user performs a predetermined touch panel operation or button operation and thereby can selectably display one of P sheets of record images on the display screen 51. The displayed record image is particularly referred to as a reference image (reference record image). It is now assumed that a reference image 510 shown in FIG. 22 is displayed, In the reference image 510, image data on a person SUB₁ and a dog SUB₂ which are a first subject and a second subject, respectively, are present.

[First reproduction operation example]

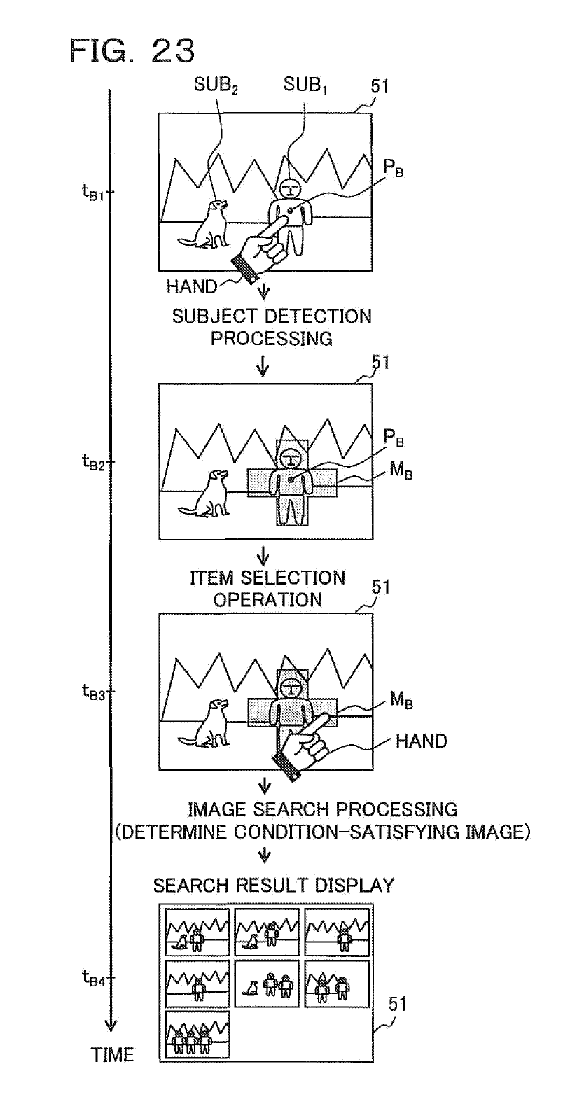

A first reproduction operation example will be described with reference to FIG. 23. FIG. 23 shows how the display screen 51 is changed in the first reproduction operation example. A time t_{Bi-1}, is assumed to be a time that is behind a time t_{Bi} (i is an integer as described previously). In FIG. 23, the picture of a hand represented by symbol HAND indicates the hand of the user. The hand HAND is not an image displayed on the display screen 51 but is the actual hand of the user.

At a time t_{B1} when the reference image 510 is displayed, the user is assumed to touch a position P_{B} on the display screen 51 (it is assumed that the display screen 51 has not been touched by the finger at all before the time t_{B1}).

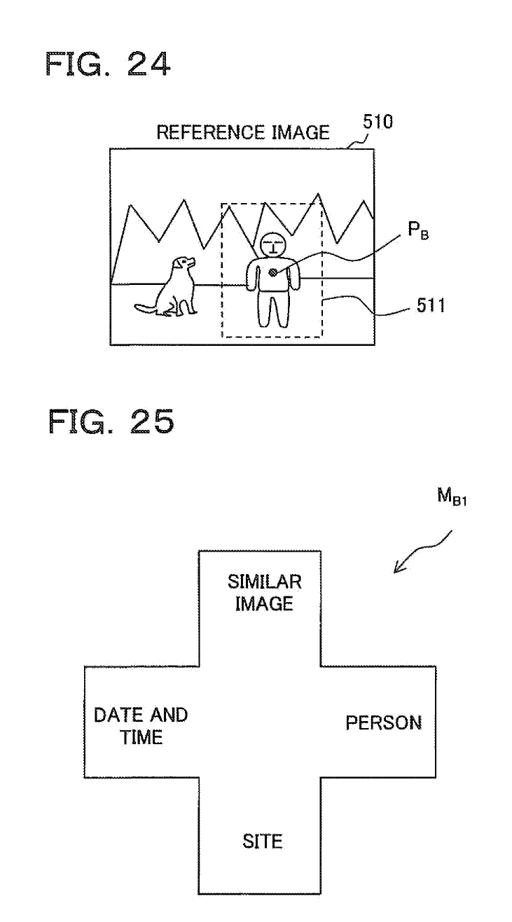

When the position P_{B} is touched, the subject detection portion 61 sets the position P_{B} to the reference position, and performs the subject detection processing for detecting the type of subject in the reference position based on image data on the reference image 510. As described previously, the subject in the reference position refers to a subject having image data in the reference position. For example, as shown in FIG. 24, the subject detection portion 61 sets, on the reference image 510, a determination region 511 whose center is located in the reference position P_{B}, detects the type of subject present within the determination region 511 based on image data within the determination region 511 and thereby detects the type of subject in the reference position. The determination region 511 is part of the entire image region of the reference image 510. As shown in FIG. 23, image data on the person SUB₁ is present in the position P_{B}. Hence, the type of subject in the reference position is determined to be the person.

After completion of the subject detection processing, the display menu production portion 62 uses the result of the subject detection processing to produce a display menu M_{B}, and the display control portion 20 displays the display menu M_{B} along with the reference image 510 on the display screen 51 at the time t_{B2}. For example, as shown in FIG. 23, the display menu M_{B} is displayed by being superimposed on the reference image 510. In this case, for example, the display menu M_{B} is displayed in such a position that its center is located in the reference position P_{B}. It is preferable to superimpose the display menu M_{B} utilizing alpha blending or the like such that an image of a portion of the reference image 510 on which the display menu M_{B} is superimposed becomes visibly transparent.

The display menu M_{B} is formed by superimposing a word, a figure or a combination thereof indicating an item to be selected, on each of the regions AR₁ to AR₄ in the basic icon M_{BASE} shown in FIGS. 12A and 12C (for specific description, it is now assumed that the item to be selected is represented by a word), In the first reproduction operation example, the center of the region AR₀ in the basic icon M_{BASE} is arranged in the reference position P_{B}. FIG. 25 shows a display menu M_{B1} as the display menu M_{B} that is actually displayed at the time t_{B2}. Although the display menu M_{B1} is actually displayed on the display screen 51 at the time t_{B2}, instead of the display menu M_{B1}, only the basic icon M_{BASE} is shown in FIG. 23 so that the figure is prevented from being complicated. The display menu M_{B1} continues to be displayed until an item selection operation, which will be described later, is performed.

Words displayed in the regions AR₂. AR₃ and AR₄ in the display menu M_{B1} are a “similar image”, a “date and time” and a “site”, respectively. The word displayed in the region AR₁ in the display menu M_{B1} is determined based on the result of the subject detection processing performed with respect to the position P_{B}. Since, in the first reproduction operation example, the type of subject in the reference position P_{B} is determined to be the person, the word displayed in the region AR₁ in the display menu M_{B1} is the “person.” The regions AR₁ to AR₄ are respectively regions in which the first to fourth items to be selected are displayed.

At a time t_{B3} behind the time t_{B2}, the user performs the item selection operation. As described in the first embodiment, the item selection operation refers to an operation of selecting any of the first to fourth items to be selected in the display menu (M_{B1} in this example). The main control portion 19 determines, based on the touch operation information, whether or not the item selection operation is performed. The method of performing the item selection operation described in the first embodiment is also applied to the second embodiment. When it is applied to the second embodiment, “M_{A}”, “M_{A1}”, “P_{A}” and “t_{Ai}” described in the first embodiment need to be replaced with “M_{B}”, “M_{B1}”, “P_{B}” and “t_{Bi}”, respectively.

As in the first embodiment, the item to be selected that is selected in the item selection operation is referred to as the selection item. When the item selection operation is performed, the image search portion 64 of FIG. 18 performs image search processing under a search condition corresponding to the selection item. Since the first to fourth items to be selected are respectively items to be selected that correspond to the regions AR₁ to AR₄ in the display menu M_{B1}, when the i-th item to be selected is selected as the selection item, the image search processing is performed under a search condition corresponding to the region AR₁. The image search portion 64 searches a non-reference image group for a record image satisfying the search condition, and outputs the result of the search to the display control portion 20. The non-reference image group refers to a plurality of record images (hence, (P−1) record images), other than the reference image 510, that are stored in the recording medium 15. Each of the images that constitute the non-reference image group is referred to as a non-reference image (a non-reference record image). The record image that satisfies the search condition is referred to as a condition-satisfying image. The condition-satisfying image is determined by the image search processing.

When the first item to be selected that corresponds to the word “person” is selected as the selection item, the image search portion 64 sets the identification of the type of subject to the search condition, and searches the non-reference image group for the condition-satisfying image that is a non-reference image including the same type of subject as the type of subject in the position P_{B} in the reference image 510. Since, in the first reproduction operation example, the type of subject in the position P_{B} in the reference image 510 is the person, the condition-satisfying image that is a non-reference image which includes a person as the subject. is searched for The image search portion 64 can search for the condition-satisfying image based on the subject information that is read from the header region of the image file of each of the non-reference images.

When the second item to be selected that corresponds to the word “similar image” is selected as the selection item, the image search portion 64 sets the similarity of an image to the search condition, and searches the non-reference image group for the condition-satisfying image that is a non-reference image including an image similar to an image within an image region with respect to the position P_{B}. Specifically, for example, a feature vector VEC₅₁₁ of the determination region 511 of the reference image 510 is first determined by the feature vector derivation processing. On the other hand, the image search portion 64 reads feature vector information from the header region of the image file of each of the non-reference images. A feature vector on a division block BL[i] of a certain sheet of a non-reference image that is represented by the feature vector information is represented by VEC_{c}[i].

The image search portion 64 determines a distance d[i] between the feature vectors VEC₅₁₁ and VEC_{c}[i]. The distance between an arbitrary first feature vector and an arbitrary second feature vector is defined as the distance (Euclidean distance) between the endpoints of the first and second feature vectors in a feature space when the starting points of the first and second feature vectors are arranged at the origin of the feature space. A computation for determining the distance d[i] is individually performed by substituting, into i, each of integers equal to or greater than one but equal to or less than six. Thus, the distances d[1] to d[6] are determined. The image search portion 64 performs the computation for determining the distances d[1] to d[6] on each of the (P−1) non-reference images, and thereby determines a total of (6×(P−1)) distances. Thereafter, a distance equal to or less than a predetermined reference distance dₘ among the (6×(P−1)) distances is identified, and a non-reference image corresponding to the identified distance is set at the condition-satisfying image. For example, when any of six distances determined on the division blocks BL[1] to BL[6] of the first non-reference image is equal to or less than the reference distance d_{TH}, the first non-reference image is determined to include an image similar to an image within the determination region 511, and the first non-reference image is set at the condition-satisfying image; when all the six distances determined on the division blocks BL[1] to BL[6] of the second non-reference image are larger than the reference distance d_{TH}, the second non-reference image is determined not to include the above similar image, and the second non-reference image is not set at the condition-satisfying image.

The non-reference image group may be searched for the non-reference image including the above similar image, utilizing the image matching or the like. Since the search utilizing the image matching or the like requires a reasonable amount of processing time, it is preferable to employ the method utilizing the feature vector information, as described above.

When the third item to be selected that corresponds to the word “date and time” is selected as the selection item, the image search portion 64 sets the similarity of the time stamp information to the search condition, and searches the non-reference image group for the condition-satisfying image that is a non-reference image shot at a time similar to a shooting time of the reference image 510. Specifically, for example, based on the time stamp information on P sheets of record images, a shooting time T₅₁₀ of the reference image 510 is compared with a shooting time of each of the non-reference images, and a non-reference image having a shooting time in which a time difference between this shooting time and the shooting time T₅₁₀ is equal to or less than a predetermined time period is set at the condition-satisfying image.

When the fourth item to be selected that corresponds to the word “site” is selected as the selection item, the image search portion 64 sets the similarity of the shooting location information to the search condition, and searches the non-reference image group for the condition-satisfying image that is a non-reference image shot at a location similar to the shooting location of the reference image 510. Specifically, for example, based on the shooting location information on P sheets of record images, the shooting location of the reference image 510 is compared with the shooting location of each of the non-reference images and thus the distance between the former and the latter is derived, and a non-reference image in which such a distance is equal to or less than a predetermined distance is set at the condition-satisfying image.

At a time t_{B4} after the image search processing, the result of the image search processing is displayed under control of the display control portion 20. For example, at the time t_{B4}, the thumbnails of the condition-satisfying images or the file names of the condition-satisfying images are displayed in a list. In FIG. 23, it is assumed that the first item to be selected which corresponds to the word “person” is selected as the selection item, and, at the time t_{B4}, the thumbnails of the condition-satisfying images, each having a person. are displayed in a list.

[Second reproduction operation example]

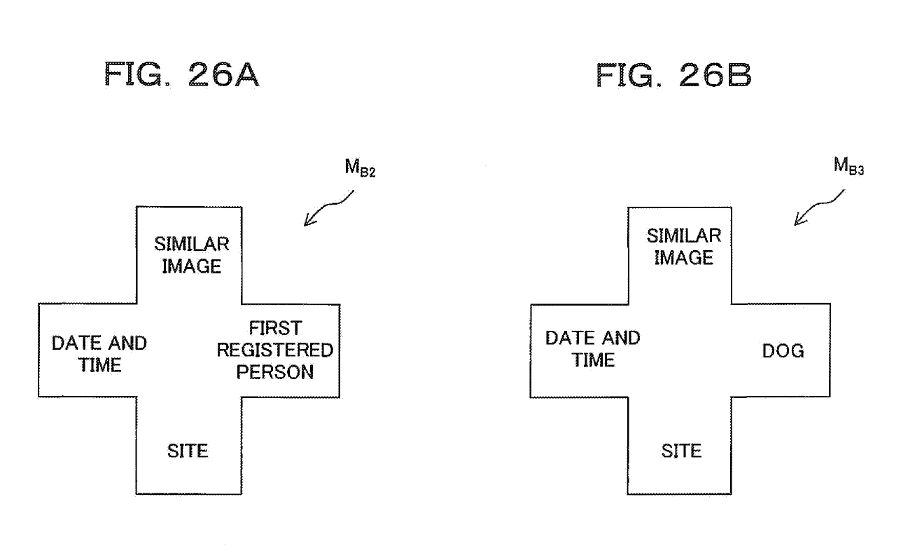

A second reproduction operation example will be described. The second reproduction operation example is a reproduction operation example obtained by varying part of the first reproduction operation example; the difference between the first and second reproduction operation examples will only be described later (the same is true in a third reproduction operation example, which will be described later). It is assumed that the subject detection processing includes the face recognition processing and that the person SUB₁ within the reference image 510 is a first registered person. In this case, since the type of subject in the reference position is determined to be the first registered person, a display menu M_{B2} of FIG. 26A is produced, and at the time t_{B2} and the subsequent times, instead of the display menu M_{B1} of FIG. 25, the display menu M_{B2} of FIG. 26A is displayed. A word “first registered person” is displayed in the region AR₁ in the display menu M_{B2}. Instead of the word “first registered person”, the preset called name (such as the name of the first registered person) of the first registered person may be displayed. The display menus M_{B1}and M_{B2} are the same except that the word displayed in region AR₁ is different.

When the first item to be selected that corresponds to the word “first registered person” is selected as the selection item, the image search portion 64 sets the identification of the type of subject to the search condition, and searches the non-reference image group for the condition-satisfying image that is a non-reference image including the first registered person of the type of subject in the position P_{B} in the reference image 510. The image search portion 64 can search for the condition-satisfying image based on the subject information that is read from the header region of the image file of the non-reference image (the same is true on the third reproduction operation example, which will be described later). In the second reproduction operation example, the operation performed when the second, third or fourth item to be selected is selected as the selection item is the same as in the first reproduction operation example (the same is true on the third reproduction operation example, which will be described later).

[Third reproduction operation example]

The third reproduction operation example will be described. When, at the time t_{B1}, instead of the displayed portion of the person SUB₁, the displayed portion of the dog SUB₂ is touched, that is, when image data on the dog SUB₂ is present in the position P_{B}, the type of subject in the reference position is determined to be the dog. Hence, a display Menu M_{B3} of FIG. 26B is produced, and at the time t_{B2} and the subsequent times, instead of the display menu M_{B1} of FIG. 25, the display menu M_{B3} of FIG. 26B is displayed. A word “dog” is displayed in the region AR₁ in the display menu M_{B3}. The display menus M_{B1} and M_{B3} are the same except that the word displayed in region AR₃ is different.

When the first item to be selected that corresponds to the word “dog” is selected as the selection item, the image search portion 64 sets the identification of the type of subject to the search condition, and searches the non-reference image group for the condition-satisfying image that is a non-reference image including the dog of the type of subject in the position P_{B} in the reference image 510.

[Operational flow chart]

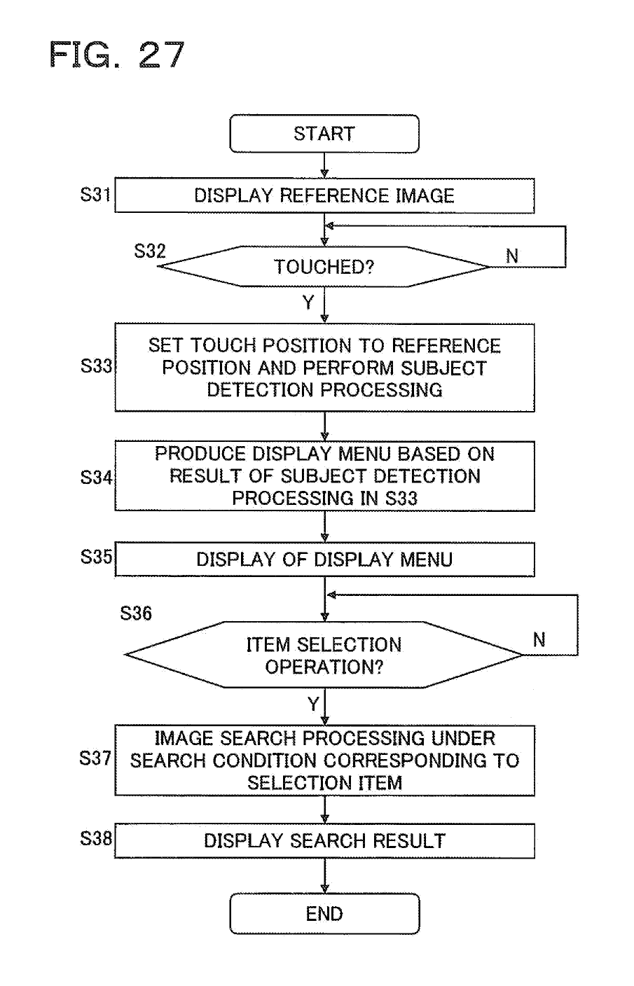

A procedure of an operation performed when the image search processing described above is utilized will now be described with reference to FIG. 27. FIG. 27 is a flowchart representing the procedure of such an operation.

In step S31, a reference image specified by the user is displayed. In step S32 subsequent to step S31, the main control portion 19 determines, based on the touch operation information, whether or not the display screen 51 is touched (that is, whether or not the display screen 51 is touched by the finger). If the display screen 51 is touched, the process moves from step S32 to step S33, and processing in steps S33 to S36 is performed step by step whereas if display screen 51 is not touched, the determination processing in step S32 is repeated.

In step S33, the image processing portion 14 and the main control portion 19 set the touched position to the reference position. In step S33, the subject detection portion 61 performs the subject detection processing for detecting the type of subject in the reference position. In step S34 subsequent to step S33, the display menu production portion 62 uses the result of the subject detection processing in step S33 to produce the display menu M_{B}; in step S35, the display control portion 20 displays the produced display menu M_{B} along with the reference image. It is possible to display the display menu M_{B} alone, The display of the display menu M_{B} is continued until the item selection operation is performed.

In step S36, the main control portion 19 determines, based on the touch operation information, whether or not the item selection operation is performed, and, only if the item selection operation is determined to be performed, the process moves from step S36 to step S37. In step S37, the image search portion 64 sets a search condition corresponding to the selection item (that is an item to be selected that is selected by the item selection operation in step S36), references details recorded in the recording medium 15 and performs the image search processing using the search condition and thereby extracts the condition-satisfying image from the non-reference image group. The result of the image search processing is displayed in step S38 subsequent to step S37, For example, as described previously, the thumbnails of the condition-satisfying images or the file names of the condition-satisfying images are displayed in a list.

When any of the thumbnails of the condition-satisfying images or any of the file names that are displayed in a list is selected by the user in the touch panel operation or the button operation, the condition-satisfying image corresponding to the selected thumbnail or file name is enlarged and displayed on the display screen 51. As necessary, the user can provide, to the image sensing device 1, an instruction (such as an instruction to send an output to an external printer) as to what type of processing needs to be performed on the enlarged and displayed condition-satisfying image.

A subject (subject at a portion touched by the user) in a position specified by the user can be considered to be a subject that is noted by the user. Hence, in the present embodiment, the type of subject in the specified position is detected, and the details of the display menu are correspondingly changed according to the result of the detection. For example, as described previously, when the subject in the specified position is the first registered person, an item to be selected for providing an instruction to search for an image including the first registered person is included in the display menu, or when the subject in the specified position is a dog, an item to be selected for providing an instruction to search for an image including a dog is included in the display menu.

When the subject in the specified position is considered to be a subject that is noted by the user, an item to be selected thereof is probably highly likely to be selected by the user after the operation of inputting the specified position. Hence, the production and the display of the display menu as described above probably facilitate enhancement of operability. For example, when the user desires to search for an image including the first registered person, in a conventional device, the user first needs to perform an operation of displaying a setting screen for input of a search condition. Thereafter, the user needs to perform, on the setting screen, an operation of including the first registered person in the search condition. By contrast, in the present embodiment, since the first registered person is touched as the noted subject and thus the display menu M_{B2} of FIG. 26A is automatically displayed through the subject detection processing, only a simple operation of, for example, sliding the finger to the displayed position corresponding to the first registered person is thereafter performed, and thus it is possible to finish providing a desired search instruction.

In the present embodiment, it is possible to simply provide an instruction to search for an image similar to an image of a portion touched by the user. In the conventional device, in order to perform a search equivalent to the above search, it is necessary to perform an operation of starting a search mode and an operation of specifying the position and size of the determination region as shown in FIG. 24. By contrast, in the present embodiment only a simple operation of, for example, sliding the finger to the position where the word “similar image” is displayed is performed after the noted subject is touched, and thus it is possible to finish providing a desired search instruction.

Although, in the example described above, the first item to be selected corresponding to the type of subject arranged in the reference position is made to correspond to the region AR₁, and the second to fourth items to be selected corresponding to the words “similar image”, “date and time” and “site” are made to correspond to the regions AR₂, to AR₄, respectively, correspondence relationships between the first to fourth items to be selected and the regions AR₁ to AR₄ are not limited to this.

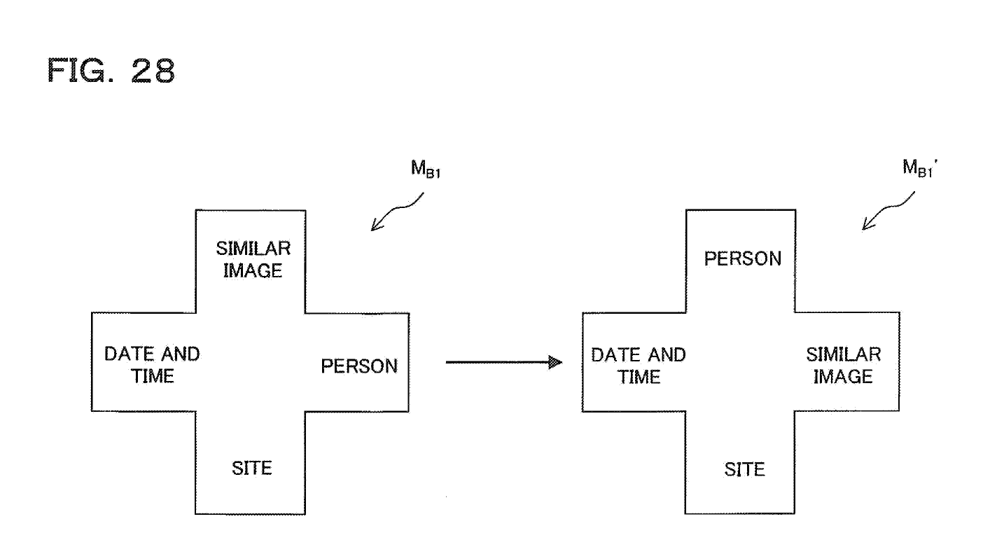

For example, as in the first embodiment, based on the history of item selection by the user, these correspondence relationships may be changed. Specifically, for example, it is assumed that, when the person on the reference image is touched, and the display menu M_{B1} is displayed, the item selection operation that selects the region AR^{,} corresponding to the word “similar image” is frequently performed. In consideration of the shape of the housing of the image sensing device 1 and the like, it is assumed that the item selection operation which selects the region AR₁ is performed more easily than the item selection operation which selects the region AR₂. The main control portion 19 stores the history of those item selection operations in the history memory (not shown) within the image sensing device 1. After the storage of the history, when another reference image including a person is displayed, and the person on the reference image is touched, as shown in FIG. 28, the display menu M_{B} displayed on the display screen 51 may be changed from the display menu M_{B1} to the display menu M_{B1}′. In the display menu M_{B1}′, the word “similar image” corresponding to the second item to be selected is shown in the region AR₁, and the word “person” corresponding to the first item to be selected is shown in the region AR₂ (in the other respects, the display menus M_{B1} and M_{B1}′ are the same as each other).

### Third embodiment

A third embodiment of the present invention will be described. The above processing based on the data recorded in the recording medium 15 can be performed by an electronic device (for example, an image reproduction device; not shown) different from the image sensing device (the image sensing device is one type of electronic device).

For example, in the image sensing device 1, a plurality of input images are acquired by shooting, and image files that store image data on the input images and the additional data described previously are recorded in the recording medium 15. Portions equivalent in function to the image processing portion 14, the display portion 17, the operation portion 18, the main control portion 19 and the display control portion 20 are provided in the present electronic device, the data recorded in the recording medium 15 is fed to the present electronic device and thus it is possible for the present electronic device to perform the processing described in the second embodiment.

### Fourth embodiment

A fourth embodiment of the present invention will be described. As in the first embodiment, image sensing devices according to the fourth embodiment and the fifth embodiment, which will be described later, are the image sensing device 1 (see FIG. 1). The description in the first embodiment is also applied to what is not particularly described in the fourth and fifth embodiments unless a contradiction arises. In the image sensing devices 1 according the fourth and fifth embodiments, the time stamp generation portion 21 and the GPS information acquisition portion 22 may be omitted.

As in the first embodiment (see FIG. 2), light enters the image sensing surface of the image sensor 33 from a subject through the optical system 35 and the aperture 32, and an optical image of the subject is formed, by the light, on the image sensing surface of the image sensor 33. The image sensor 33 photoelectrically converts the optical image and outputs to the AFE 12 an electrical signal obtained by the photoelectrical conversion. Image data on a certain image refers to a digital signal indicating the details of the image.

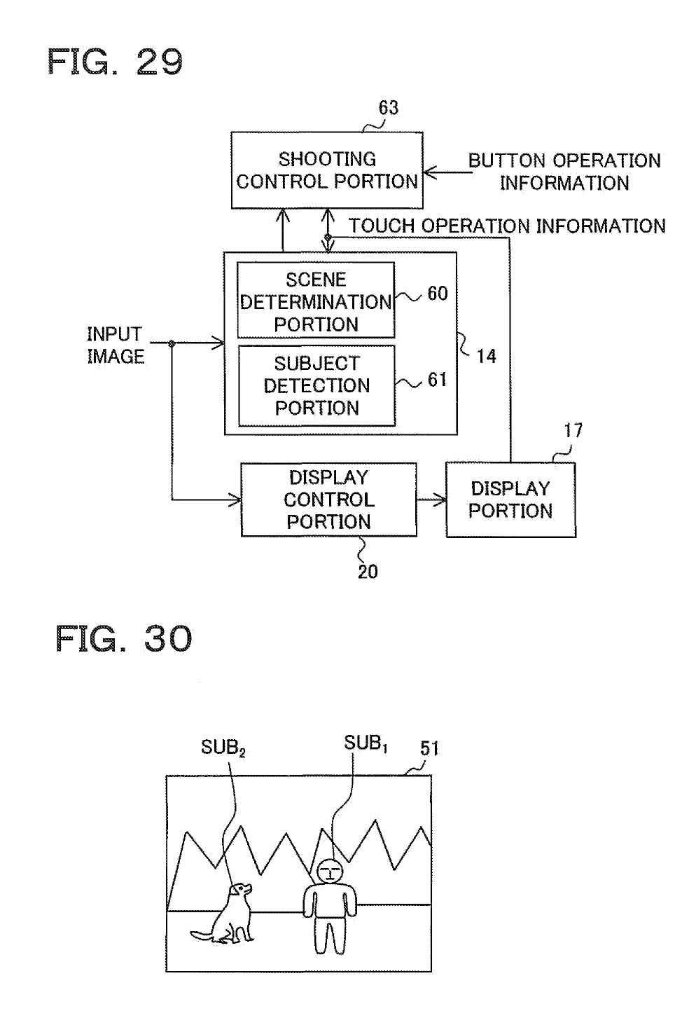

In the fourth embodiment, the operation of the image sensing device 1 in the first operation mode in winch a still image or a moving image can be shot will be described. FIG. 29 is a partial block diagram of the image sensing device 1 that is particularly involved in the operation of the fourth embodiment. Image data on the input image is fed to the image processing portion 14 and the display control portion 20 shown in FIG. 29.

The scene determination portion 60, the subject detection portion 61 and the display control portion 20 shown in FIG. 29 are the same as those shown in FIG. 6. Hence, the scene determination portion 60 performs the scene determination processing, and the subject detection portion 61 performs the subject detection processing. The display control portion 20 can display the input image sequence as a moving image on the display screen 51.

The shooting control portion 63 shown in FIG. 29 is also the same as that shown in FIG. 6. Based on the result of the scene determination processing, the shooting control portion 63 can select, from the first to N-th shooting modes, one shooting mode that is considered to be the optimum shooting mode as the shooting mode of the target image. When the determination scene is different, the shooting mode to be selected is generally different. As in the first embodiment, the shooting mode selected here is referred to as the selection shooting mode. All or part of the shooting conditions of the target image is specified by the selection shooting mode.

[Shooting Operation Example J₁]

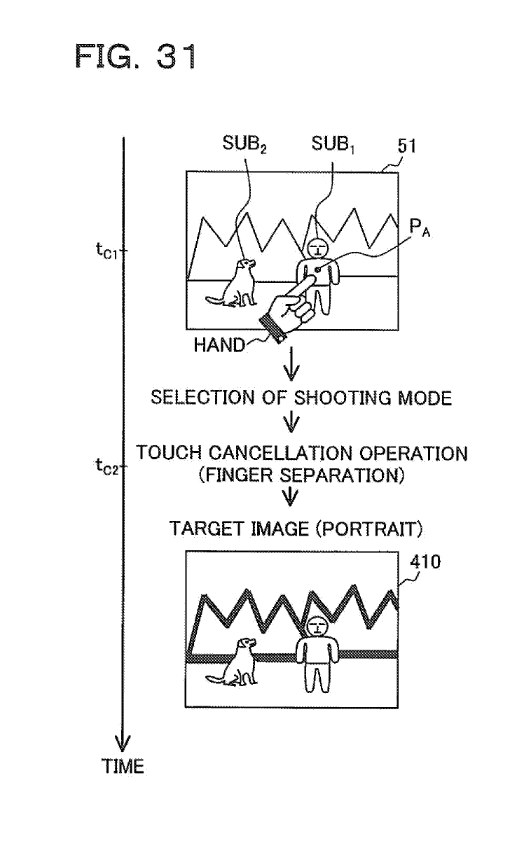

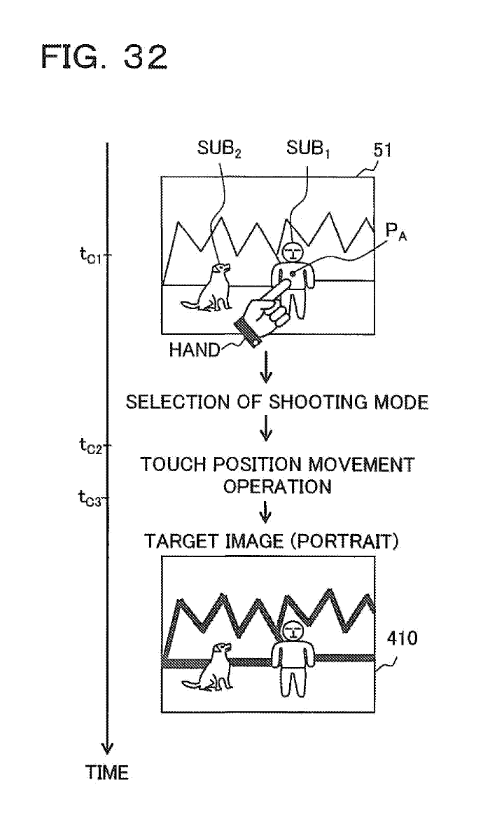

A shooting operation example J₁ of the image sensing device 1 will now be described with reference to FIGS. 30 and 31. The assumption α described in the first embodiment is also applied to the shooting operation example J₁. In other words, in the shooting operation example J₁, it is assumed that a person SUB₁ which is a first subject, a dog SUB₂ which is a second subject and a mountain arranged behind the person SUB₁ and the dog SUB₂ are included in the shooting range of the image sensing portion 11. FIG. 30 shows the display screen 51 under the assumption α. How the display screen 51 is changed and an example of the target image obtained when the user shoots the target image under the assumption α are shown in FIG. 31. A time t_{Ci+1} is assumed to be a time that is behind a time t_{Ci}. The “i” is an integer. In FIG. 31, the picture of a hand represented by symbol HAND indicates the hand of the user (the same is true in FIG. 32, which will be described later). The hand HAND is not an image displayed on the display screen 51 but is the actual hand of the user.

At a time t_{C1}, the user touches a position P_{A} on the display screen 51 (it is assumed that the display screen 51 has not been touched by a finger at all before the time t_{C1}). A touch refers to an operation of touching a specific portion on the display screen 51 by a finger.

When the position P_{A} is touched, the subject detection portion 61 sets the position P_{A} to the reference position, and performs, based on image data on the input image at the present time, the subject detection processing for detecting the type of subject in the reference position. The subject in the reference position refers to a subject having image data in the reference position. For example, as shown in FIG. 11, the subject detection portion 61 sets, on the input image 400, a determination region 401 whose center is located in the reference position P_{A}, detects the type of subject present within the determination region 401 based on image data within the determination region 401 and thereby detects the type of subject in the reference position. The input image 400 is either an input image shot at the time t_{C1} or an input image shot immediately after the time t_{C1}. The input image 400 may be shot after the time t_{C1}, and the input image 400 may also be shot before the target image 410 described later is shot. The determination region 401 is part of the entire image region of the input image 400. Although an arbitrary determination region which the determination region 400 is typical of may be formed in a shape other than a rectangle, it is assumed to be rectangular.

In the shooting operation example J₁, as shown in FIG. 31, image data on the person SUB₁ is present in the position P_{A}. Hence, the type of subject in the reference position is determined to be the person. The shooting control portion 63 performs shooting mode selection processing together with the scene determination portion 60. In the shooting mode selection processing, the scene determination processing is performed based on the type of subject in the reference position, and the selection shooting mode is determined from the result of the scene determination processing. A word or an icon indicating the determination scene or the selection shooting mode that has been determined may be displayed on the display screen 51 along with the input image at the present time (the same is true in a shooting operation example J₂, which will be described later).

In the example of FIG. 31, since the type of subject in the reference position is determined to be the person, the portrait scene is selected as the determination scene by the shooting mode selection processing, and consequently, the selection shooting mode is set at the portrait mode. In an example different from the example of FIG. 31, if the type of subject in the reference position is the dog, the animal scene is selected as the determination scene by the shooting mode selection processing, and consequently, the selection shooting mode is set at the high-speed shutter mode.

Although, in the shooting mode selection processing described above, the selection shooting mode is determined utilizing the result of the detection of the type of subject in the reference position, the selection shooting mode may be determined without the result of the detection of the type of subject in the reference position being utilized. In this case, preferably, the scene determination processing is performed based on image data within the determination region 401, and the selection shooting mode is determined using the result of the scene determination processing. The same is true in the shooting operation example J₂, which will be described later.

At a time t_{C2}, a touch cancellation operation is performed by the user. The touch cancellation operation refers to an operation of separating a finger in contact with the display screen 51 from the display screen 51. In other words, the touch cancellation operation refers to an operation of changing the state where the finger is in contact with the display screen 51 to the state where the finger is not in contact with the display screen 51.

When the shooting control portion 63 determines, based on the touch operation information, that the touch cancellation operation is performed, the shooting control portion 63 makes the image sensing portion 11 and the image processing portion 14 immediately shoot the target image in the selection shooting mode determined in the shooting mode selection processing (makes them produce image data on the target image). Hence, in the shooting operation example J₁, the touch cancellation operation performed after the reference position is touched functions as the shutter instruction. Consequently, the target image 410 obtained by shooting in the selection shooting mode (the portrait mode in example of FIG. 31) is acquired.

[Shooting operation example J₂]

The shooting operation example J₂ of the image sensing device 1 under the above assumption α will now be described with reference to FIG. 32. How the display screen 51 is changed and an example of the target image obtained in the shooting operation example J₂ are shown in FIG. 32. The details of the display screen 51 at the time t_{C1} and an example of the obtained target image are the same between the FIGS. 31 and 32.

At the time t_{C1}, the user touches the position P on the display screen 51 (it is assumed that the display screen 51 has not been touched by a finger at all before the time t_{C1}). When the position P_{A} is touched, the subject detection portion 61 sets the position P_{A} to the reference position, and performs, based on image data on the input image at the present time, the subject detection processing for detecting the type of subject in the reference position. The shooting control portion 63 utilizes the result thereof to perform the shooting mode selection processing. The method of detecting the type of subject in the reference position and the method of performing the shooting mode selection processing are the same as those in the shooting operation example J₁.

In the shooting operation example J₂, a touch position movement operation is performed between the time t_{C2} and time t_{C3}. The touch position movement operation refers to an operation of moving the finger from the reference position P_{A}, which is a starting point, to a position P_{A}′, which is different from the reference position P_{A}, with the finger in contact with the display screen 51. In the shooting operation example J₂, between the time t_{C2} and time t_{C3}, the position where the finger is in contact with the display screen 51 is moved by the user from the reference position P_{A} to the position P_{A}′.

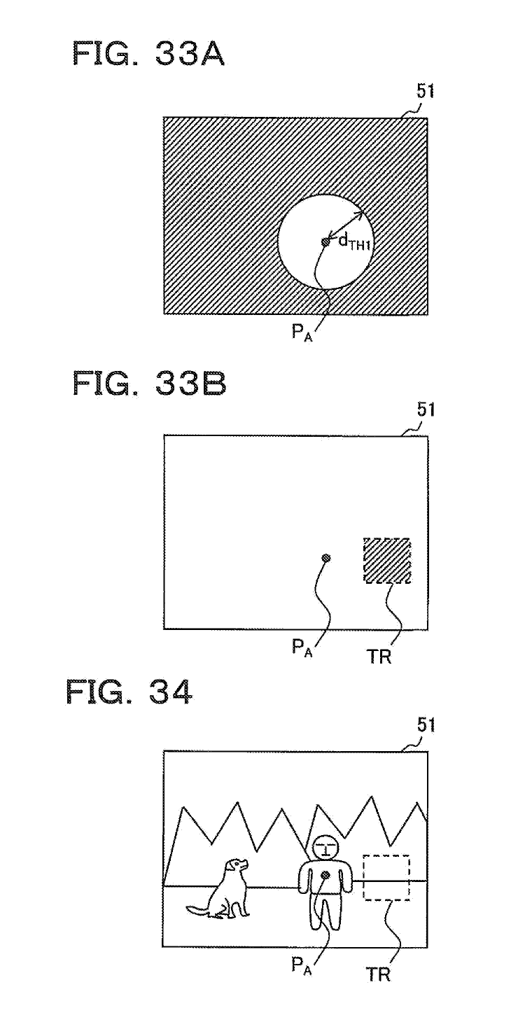

On the display screen 51, an arbitrary position in winch a distance between this position and the position P_{A} is equal to or more than a predetermined distance d_{TH1} can be assumed to be the position P_{A}′ (d_{TH1}>0). In other words, an arbitrary position within a shaded region shown in FIG. 33A can be treated as the position P_{A}′. In this case, it can also be said that the touch position movement operation refers to an operation of moving the finger from the reference position P_{A}, which is the starting point, by the predetermined distance d_{TH1} or more, with the finger in contact with the display screen 51.

Alternatively, as shown in FIG. 33B, a target region TR may be set on the display screen 51 with respect to the reference position P_{A}, and an arbitrary position within the target region TR may be treated as the position P_{A}′. In FIG. 33B, a shaded region corresponds to the target region TR. Naturally, the reference position P_{A} is not present within the target region TR. When the target region TR is set, as shown in FIG. 34, after the time t_{C1}, an indicator that indicates which region on the display screen 51 is the target region TR is preferably displayed on the display screen 51. In FIG. 34, this indicator is shown as a broken line frame.

When the shooting control portion 63 determines, based on the touch operation information, that the touch position movement operation is performed, the shooting control portion 63 makes the image sensing portion 11 and the image processing portion 14 immediately shoot the target image in the selection shooting mode determined in the shooting mode selection processing (makes them produce image data on the target image). Hence, in the shooting operation example J₂, the touch position movement operation performed after the reference position is touched functions as the shutter instruction. Since, in the example of FIG. 32, as in the example of FIG. 31, the type of subject in the reference position is determined to be the person, the portrait scene is selected as the determination scene and the selection shooting mode is set at the portrait mode by the shooting mode selection processing. Consequently, the target image 410 obtained by shooting in the portrait mode is acquired.

In the present embodiment the target image can be acquired under the shooting conditions suitable for the subject in the touched position (P_{A},). In this case, the shutter instruction of the target image can be performed by conducting an inevitable operation (touch cancellation operation) of separating the finger in contact with the display screen from the display screen or a simple operation (touch position movement operation) of sliding the finger in contact with the display screen on the display screen, Hence, in the present embodiment, as compared with the second and third conventional methods described above, an operational burden placed on the user is reduced. Moreover, in a sequential operation of touching the display screen and then separating the finger in contact with the display screen from the display screen or in a sequential operation of touching the display screen and then sliding the finger in contact with the display screen on the display screen, an instruction to set the shooting conditions (scene determination instruction) and an instruction to shoot the target image can be provided, with the result that extremely excellent operability is achieved.

The shake of the housing of the image sensing device 1 resulting from the touch cancellation operation or the touch position movement operation is probably smaller than that resulting from the operation (operation of pressing the shutter button on the display screen) of the shutter instruction in the third conventional method. Hence, in the present embodiment, the blurring of the target image resulting from the operation of the shutter instruction is reduced.

### A Fifth Embodiment

A fifth embodiment of the present invention will be described. The fifth embodiment is an embodiment obtained by varying part of the fourth embodiment; the description in the fourth embodiment is also applied to what is not particularly described in the fifth embodiment. In the fifth embodiment, the same effects as in the fourth embodiment are obtained.

AF control and AE control that can be performed by the image sensing device 1 will first be described.

In the AF control, the position of the focus lens 31 (see FIG. 2) is adjusted under control of the shooting control portion 63 of FIG. 6 or FIG. 29 so that any of subjects positioned within the shooting range of the image sensing device 1 is focused. When this adjustment is completed and the position of the focus lens 31 is fixed, the AF control is completed. As the method of performing the AF control, an arbitrary method among methods including known methods can be utilized.

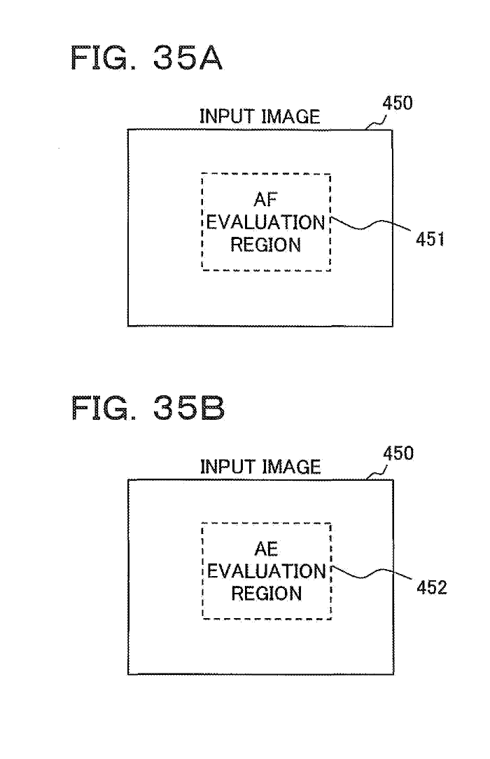

For specific description, it is now assumed that AF control using a contrast detection method of a TTL (through the lens) mode is employed. As shown in FIG. 35A, an unillustrated AF evaluation value calculation portion provided in the main control portion 19 or the image processing portion 14 shown in FIG. 1 sets an AF evaluation region within an input image 450 that is an arbitrary input image, and calculates an AF evaluation value having a value corresponding to the contrast of an image within the AF evaluation region, based on image data within the AF evaluation region, using a high pass filter or the like. Here, the AF evaluation region is assumed to be part of the entire image region of the input image 450. In FIG. 35A, a region within a broken line rectangular frame represented by reference numeral 451 is the AF evaluation region. The AF evaluation value is increased as the contrast of an image within the AF evaluation region is increased. In a sequential manner, the AF evaluation value is calculated as described above each time the position of the focus lens 31 is moved a predetermined distance, and the maximum AF evaluation value is identified from a plurality of AF evaluation values obtained. The position of the focus lens 31 corresponding to the maximum AF evaluation value is referred to as a focusing lens position, The AF control is completed by fixing the actual position of the focus lens 31 to the focusing lens position. When the AF control is completed, the image sensing device 1 can provide a notification (such as the output of an electronic sound) of the completion of the AF control.

In the AF control, the degree of opening (that is an aperture value) of the aperture 32 and the ISO sensitivity are adjusted under control of the shooting control portion 63 of FIG. 6 or FIG. 29 so that the appropriate brightness of the input image or the target image is obtained. As shown in FIG. 35B, an unillustrated AE evaluation value calculation portion provided in the main control portion 19 or the image processing portion 14 shown in FIG. 1 sets an AE evaluation region within the input image 450, and calculates, as an AE evaluation value, the average brightness of an image within the AE evaluation region based on image data within the AE evaluation region. Here, the AE evaluation region is assumed to be part of the entire image region of the input image 450, In FIG. 35B, a region within a broken line rectangular frame represented by reference numeral 452 is the AE evaluation region. Based on the AE evaluation value, the shooting control portion 63 adjusts either or both of the degree of opening (that is, an aperture value) of the aperture 32 and the ISO sensitivity such that the AE evaluation value of an input image obtained after the AE control is a desired value (for example, a predetermined reference value).

A technology applicable to the shooting operation examples J₁ and J₂ described previously and corresponding to FIGS. 31 and 32 will now be described. When the position P_{A} is touched at the time t_{C1}, a subject having image data in the position P_{A} that is the reference position may be regarded as the target subject, and AF control (hereinafter, particularly referred to as specific AF control) for focusing on the target subject may be performed. In addition to or instead of this AF control, AE control (hereinafter, particularly referred to as specific AE control) for optimizing the exposure to the target subject may be performed.

The specific AF control is performed during a specific time period from the time t_{C1} until the target image 410 is shot. Specifically, for example, the above AF control is performed while the AF evaluation region with respect to the position P_{A} is set on each of input images obtained during the specific time period, and thus the focusing lens position is searched for and the actual position of the focus lens 31 is fixed to the focusing lens position. Thereafter, the touch cancellation operation or the touch position movement operation is performed, and the target image 410 is shot with the position of the focus lens 31 arranged in the focusing lens position. The AF evaluation region with respect to the position P_{A} is, for example, a rectangular region whose center is located in the position P_{A}, and may be the same as the determination region 401 of FIG. 11. With the specific AF control, it is possible to obtain the target image in which the target subject is focused.

In the specific AE control, the above AE control is performed while the AE evaluation region with respect to the position P_{A} is set on each of the input images obtained during the above specific time period. Thus, either or both of the degree of opening (that is, an aperture value) of the aperture 32 and the ISO sensitivity is adjusted such that the AE evaluation value of an input image which is the source of the target image 410 is a desired value (for example, a predetermined reference value). The AE evaluation region with respect to the position P_{A} is, for example, a rectangular region whose center is located in the Position P_{A}, and may be the same as the determination region 401 of FIG. 11. With the specific AE control, it is possible to obtain the target image in which the exposure of the target subject is optimized.

The adjustment of the position of the focus lens 31 using the AF control, the adjustment of the degree of opening (that is, an aperture value) of the aperture 32 using the AE control and the adjustment of the ISO sensitivity using the AE control belong to the adjustment of the shooting conditions of the input image or the target image. Although, in the fifth embodiment, the method of adjusting the shooting conditions with the target subject noted is described above, the shooting conditions to be adjusted are not limited to those described above. For example, AWB control for optimizing the white balance of the target subject in the target image may be performed; the execution of AWB control here is also said to belong to the adjustment of the shooting conditions of the input image or the target image.

<<Variations and the like>>

Specific values indicated in the above description are simply illustrative; they can be naturally changed to various values. As explanatory notes that can be applied to the above embodiments, explanatory notes 1 to 6 will be described below. The details of the explanatory notes can be freely combined unless a contradiction arises.

[Explanatory note 1]

Although, in the embodiments described above, the number of items to be selected included in the display menu (M_{A} or M_{B}) is four, the number may be a number other than four. Although, in the first embodiment described previously, two of the items to be selected included in the display menu can be changed according to the result of the subject detection processing with respect to the reference position P_{A}, the number of items to be selected that are determined according to the result of the subject detection processing may be one or three or more. Likewise, although, in the second embodiment described previously, one of the items to be selected included in the display menu can be changed according to the result of the subject detection processing with respect to the reference position P_{B}, the number of items to be selected that are determined according to the result ,of the subject detection processing may be two or more.

[Explanatory Note 2]

Although, in the embodiments described above, the touch panel operation performed by the user specifies the reference position, the button operation performed by the user may specify the reference position.

[Explanatory Note 3]

Although, in the embodiments described above, the recording medium 15 is assumed to be arranged in the image sensing device 1, the recording medium 15 may be arranged outside the image sensing device 1.

[Explanatory Note 4]

The image sensing device 1 may be incorporated in an arbitrary device (a mobile terminal such as a mobile telephone).

[Explanatory Note 5]

The image sensing device 1 of FIG. 1 and the electronic device of the third embodiment can be formed with hardware or a combination of hardware and software. When the image sensing device 1 or the electronic device is formed with software, a block diagram of portions that are provided by software indicates a functional block diagram of those portions. By writing, as a program, a function achieved with software and performing the program on a program execution device (for example, computer), the function may be achieved.

[Explanatory Note 6]

The subject can be replaced with an object; the subject detection portion which the subject detection portion 61 of FIG. 6 or FIG. 29 is typical of can also be called an object detection portion or an object type detection portion.

What is claimed is:

1. An electronic device comprising:
a display portion that includes a display screen on which an input image is displayed;
a specification reception portion that receives an input indicating a specified position on the input image;
an object type detection portion that detects a type of object in the specified position based on image data on the input image; and
a display menu production portion that produces a display menu displayed on the display screen,
wherein the display menu production portion changes details of the display menu according to the type of object detected by the object type detection portion

2. The electronic device of claim 1,
wherein the display menu includes a plurality of items, and
when the electronic device receives an item selection operation of selecting any of the items, the electronic device shoots an image under a shooting condition corresponding to the selected item.

3. The electronic device of claim 1,
wherein the display menu includes a plurality of items, and
when the electronic device receives an item selection operation of selecting any of the items, the electronic device searches a plurality of record images stored in a recording medium for a condition-satisfying image under a search condition corresponding to the selected item, and displays a result of the search on the display screen.

4. The electronic device of claim
wherein the item selection operation is performed either on a touch panel provided in the display portion or on an operation portion provided m the electronic device.

5. An image sensing device including a display portion having a touch panel,
wherein the image sensing device shoots a target image
either when an operation member comes in contact with a display screen of the display portion and thereafter the operation member is separated from the display screen or
when the operation member comes in contact with the display screen and thereafter the operation member moves on the display screen while in contact with the display screen.

6. The image sensing device of claim 5, further comprising:
an image sensing portion that outputs, by shooting, a signal indicating an optical image of a subject; and
a shooting control portion that controls the image sensing portion,
wherein the shooting control portion sets or adjusts, when the operation member comes in contact with the display screen on which an input image based on an output signal of the image sensing portion is displayed, a shooting condition based on image data on the input image in a position where the display screen conies in contact with the operation member, and thereafter, either when the operation member is separated from the display screen or when the operation member moves on the display screen while in contact with the display screen, the target image is shot under the shooting condition set or adjusted by the image sensing portion.
